(19) United States
(12) Patent Application Publication
(10) Pub. No.: US 2026/0328735 A1
(43) Pub. Date: Oct. 22, 2026

(54) CHROMATOGRAPHY SYSTEM WITH DIFFERENT INJECTION SETUPS

(71) Applicant: Dionex Softron GmbH, Germering (DE)

(72) Inventor: Thomas Wachinger, Altomünster (DE)

(21) Appl. No.: 19/180,261

(22) Filed: Apr. 16, 2025

(51) Int. Cl. G01N 30/20; G01N 30/02; G01N 30/32

(52) U.S. Cl. CPC G01N 30/20; G01N 30/32; G01N 2030/027; G01N 2030/201; G01N 2030/202; G01N 2030/207; G01N 2030/324; G01N 2030/326; G01N 2030/328

(57) ABSTRACT

The present invention relates to a method for operating a chromatography system, comprising operating the chromatography system in a first injection setup S₁, a second injection setup S₂ and a third injection setup S₃, wherein in each injection setup, different system components are comprised in an analytical path between the solvent pump and the separation column during sample injection. Furthermore, the present invention relates to a respective chromatographic system and valve.

The present invention generally relates to a chromatography system comprising an injection valve, preferably a liquid chromatography (LC) system and a corresponding method. More specifically, the present invention may relate to a chromatography system which can be operated in three different injection setups and a respective method.

Injection valves may be used in autosamplers to inject a sample to be analysed in a solvent stream. For this purpose, the sample may first be drawn into a sample loop at atmospheric pressure and then be pre-compressed to system pressure. During injection, the sample may then be transported by the solvent pump towards the analytical column, which separates the sample components over time. The analytes may then be determined in a downstream detector. The injection valve may typically be designed as a shear valve with ports and grooves, and configured such that different components can be fluidly connected or separated.

In the following, the present invention is generally discussed with reference to high-performance liquid chromatography (HPLC). However, it will be understood that the present invention may also relate to other LC methods and systems, e.g. LC or ultra high performance liquid chromatography (UHPLC).

Generally, it may be advantageous to provide a user with an option to perform different injection methods within one system. In that regard U.S. Pat. No. 11,275,062 B2 discloses two injection principles within a single valve, namely feed injection and flow-through injection. In particular, an injection valve is disclosed that is suitable for split-loop injection without a metering device in the analytical path and for feed injection. In feed injection, the sample is pressed into the analytical path so that a resulting flow to the separation column is created, which consists of the sample flow and the solvent flow of the pump.

A disadvantage of this solution is that the user cannot make any adjustments to the gradient delay volume (GDV), as the metering device cannot be switched into the analytical path. Furthermore, the disclosed system does also not allow for pushed-loop injection, such as full-loop injection or partial-loop injection.

In other words, the system disclosed in U.S. Pat. No. 11,275,062 B2 may only provide a solution for users who, in addition to their standard split-loop injection, can also apply their sample to the column in diluted form. However, often it may be desirable to analyse samples in an undiluted form.

Furthermore, stator grooves are required alongside rotor grooves, which increases the complexity and thus manufacturing costs due to additional machining of the stator. Additionally, stator grooves are also susceptible to carryover, as they may contain solvent or sample residues from a previous switching position of the valve.

Additionally, the outer stator ports (without the centre port) disadvantageously do not lie on a single circular path, but on two. Thus, the distance between the ports is also different. However, capillaries must be screwed into the minimum of 8 ports, which must be distributed on the stator cap. The result may either be an uneven distribution of the port inlets and the associated partial lack of space for simply screwing in the capillaries, or the stator bores may have to run at different angles towards the rotor which would greatly increase complexity and cost of the valve.

In light of the above, it is an object to overcome or at least alleviate the shortcomings and disadvantages of the prior art. More particularly, it is an object of the present invention to provide a chromatography system and/or autosampler which provides a plurality, preferably at least three, types of injection within a single hardware setup.

These objects are met by the present invention.

In a first embodiment, the present invention relates to a valve for a liquid chromatography system, wherein the valve comprises at least 8 ports, wherein the at least 8 ports comprise a first port, a second port, a third port, a fourth port, a fifth port, a sixth port, a seventh port, and an eighth port; wherein the valve comprises at least 4 connecting elements for connecting the ports, wherein the at least 4 connecting elements comprise a first connecting element, a second connecting element, a third connecting element, and a fourth connecting element; wherein the valve is configured to assume a first valve position, wherein the first connecting element connects the first port and the eighth port free of dead volume, wherein the second connecting element connects the second port and the third port free of dead volume, wherein the third connecting element connects the fourth port and the fifth port free of dead volume, and wherein the fourth connecting element connects the sixth port and the seventh port free of dead volume.

It will be understood that a valve position generally refers to a relative position of connecting elements and ports of the valve. For example, in case of a shear valve comprising a stator and a rotor, a valve position may be determined by the relative position of stator and rotor. Thus, each valve position corresponds to a respective configuration of the valve and may also be referred to as valve configuration.

Furthermore, the valve may be configured to assume a second valve position, wherein the first connecting element connects the first port and the fourth port free of dead volume, wherein the second connecting element connects the fifth port and the sixth port free of dead volume, wherein the third connecting element connects the seventh port and the eighth port free of dead volume, and wherein the fourth connecting element connects the second port and the third port free of dead volume.

Very generally, such a valve may advantageously allow for a system utilizing the valve as injection valve, to provide different injection setups, e.g. two or three different injection setups, without a need to change any hardware of the valve. The different injection setups may preferably allow for different injection procedures.

The valve may be configured to assume a third valve position, wherein the first connecting element connects the first port and the second port free of dead volume, wherein the second connecting element connects the third port and the fourth port free of dead volume, wherein the third connecting element connects the fifth port and the sixth port free of dead volume, and wherein the fourth connecting element connects the seventh port and the eighth port free of dead volume.

The valve may be configured to assume a fourth valve position, wherein the first connecting element connects the first port and the fifth port free of dead volume, wherein the second connecting element connects the sixth port and the seventh port free of dead volume, wherein the third connecting element connects the eighth port and the second port free of dead volume, and wherein the fourth connecting element connects the third port and the fourth port free of dead volume.

The valve may be configured to assume a fifth valve position, wherein the first connecting element connects the first port and the second port with dead volume being present in the first connecting element, wherein the second connecting element is only connected to the third port, wherein the third connecting element is only connected to the fifth port, wherein the fourth connecting element connects the seventh port and the eighth port with dead volume being present in the fourth connecting element, and wherein the fourth port and the sixth port are not connected to any of the four connecting elements.

The valve may be configured to assume a sixth valve position, wherein the first connecting element connects the first port and the fifth port with dead volume being present in the first connecting element, wherein the second connecting element is only connected to the sixth port, wherein the third connecting element is only connected to the eighth port, wherein the fourth connecting element is not connected to any of the 8 ports, and wherein the second port, third port, the fourth port and the seventh port are not connected to any of the four connecting elements.

The valve may be configured to assume a seventh valve position, wherein the first connecting element connects the first port and the fifth port with dead volume being present in the first connecting element, wherein the second connecting element is only connected to the sixth port, wherein the third connecting element is only connected to the eighth port, wherein the fourth connecting element connects the third port and the fourth port with dead volume being present in the fourth connecting element, and wherein the second port, and the seventh port are not connected to any of the four connecting elements.

The valve may be configured to assume an eighth valve position, wherein the first connecting element is only connected to the first port, wherein the second connecting element is only connected to the fourth port, wherein the third connecting element is only connected to the sixth port, wherein the fourth connecting element is not connected to any of the 8 ports, and wherein the second port, third port, the fifth port, the seventh port and the eight port are not connected to any of the four connecting elements.

The valve may be configured to assume a ninth valve position, wherein the first connecting element connects the first port and the eighth port with dead volume being present in the first connecting element, wherein the second connecting element is only connected to the second port, wherein the third connecting element is only connected to the fourth port, wherein the fourth connecting element connects the sixth port and the seventh port with dead volume being present in the fourth connecting element, and wherein the third port and the fifth port are not connected to any of the four connecting element.

The valve may be configured to assume a tenth valve position, wherein the first connecting element connects the first port and the sixth port with dead volume being present in the first connecting element, wherein the second connecting element is only connected to the seventh port, wherein the third connecting element is only connected to the second port, wherein the fourth connecting element is not connected to any of the 8 ports, and wherein the third port, the fourth port, the fifth port, and the eight port are not connected to any of the four connecting elements.

The valve may be configured to assume an eleventh valve position, wherein the first connecting element connects the first port and the seventh port with dead volume being present in the first connecting element, wherein the second connecting element is only connected to the eighth port, wherein the third connecting element is only connected to the third port, wherein the fourth connecting element is not connected to any of the 8 ports, and wherein the second port, the fourth port, the fifth port, and the sixth port are not connected to any of the four connecting elements.

The valve may be configured to assume a twelfth valve position, wherein the first connecting element connects the first port and the sixth port free of dead volume, wherein the second connecting element connects the seventh port and the eighth port free of dead volume, wherein the third connecting element connects the second port and the third port free of dead volume, and wherein the fourth connecting element connects the fourth port and the fifth port free of dead volume.

The valve may be configured to assume a thirteenth valve position, wherein the first connecting element connects the first port and the second port with dead volume being present in the first connecting element, wherein the second connecting element is only connected to the third port, wherein the third connecting element is only connected to the fifth port, wherein the fourth connecting element is not connected to any of the 8 ports, and wherein the fourth port, the sixth port, the seventh port, and the eighth port are not connected to any of the four connecting elements.

The valve may be configured to assume a fourteenth valve position, wherein the first connecting element is only connected to the first port, wherein the second connecting element is only connected to the third port, wherein the third connecting element is only connected to the fifth port, wherein the fourth connecting element is not connected to any of the 8 ports, and wherein the second port, fourth port, the sixth port, the seventh port, and the eighth port are not connected to any of the four connecting elements.

The valve may be configured to assume a fifteenth valve position, wherein the first connecting element connects the first port and the eighth port with dead volume being present in the first connecting element, wherein the second connecting element is only connected to the second port, wherein the third connecting element is only connected to the fourth port, wherein the fourth connecting element is not connected to any of the 8 ports, and wherein the third port, the fifth port, the sixth port, and the seventh port are not connected to any of the four connecting elements.

The valve may be configured to assume a sixteenth valve position, wherein the first connecting element connects the first port and the seventh port free of dead volume, wherein the second connecting element connects the eighth port and the second port free of dead volume, wherein the third connecting element connects the third port and the fourth port free of dead volume, and wherein the fourth connecting element connects the fifth port and the sixth port free of dead volume.

The valve may generally be a shear valve comprising a rotor and a stator. The at least 8 ports may be comprised by the stator. That is, all ports may be comprised by the stator. The first port may be located at a centre of the stator, while the remaining 7 ports may be located equally spaced in a circumferential direction on a circle around the first port.

The at least 4 connecting elements may be located in the stator and/or rotor, preferably only in the rotor. The at least 4 connecting elements may be provided through grooves in the stator and/or rotor, preferably only in the rotor.

The first connecting element may be generally hook-shaped and dimensioned such that it can fluidly connect the first port to each of the other ports, respectively. That is, the first connecting element may be configured to fluidly connect the first port to any selected one of any of the other ports. Thus, it may selectively provide a fluidic connection between the first port any of the other ports.

In embodiments, wherein the 7 ports other than the first port are located equally spaced in the circumferential direction on the circle around the first port, the second and third connecting element may comprise the shape of an arc oriented along the circle and dimensioned such that they can connect two neighbouring ports on the circle without any dead volume in said connection.

Similarly, in embodiments, wherein the 7 ports other than the first port are located equally spaced in the circumferential direction on the circle around the first port, the fourth connecting element may comprise a shape that allows to connect two neighbouring ports on the circle both with or without dead volume.

Each of the ports may be point shaped.

In another embodiment, the present invention relates to a method for operating a chromatography system, wherein the chromatography system comprises an injection valve comprising at least 8 ports, a metering device, a separation column, a solvent pump, a sample loop, a waste, at least one washing pump, and a sample pickup means and a seat for receiving the sample pick-up means. The method comprising operating the chromatography system in a first injection setup S₁, a second injection setup S₂ and a third injection setup S₃, wherein in each injection setup, different system components are comprised in an analytical path between the solvent pump and the separation column during sample injection. Operating the system in different injection setups may allow for realizing different injection principles, such as split-loop injection with and without the metering device being part of the analytical path and/or pushed-loop injection.

Preferably, changing between different injection setups (S₁, S₂, S₃) may not require any hardware modifications other than changing fluidic connections between system components and optionally changing the sample loop. That is, no parts or portions of the system need to be exchanged, e.g. the rotor may remain the same for all injection setups, and merely fluidic connections may be swapped and changed. It will be understood that the sample loop, which may typically be a capillary, may optionally be exchanged, particularly when operating in the third injection setup to comprise a desired volume for a full loop injection. This may generally be advantageous as changing fluidic connections may be a routine operation that can easily be carried out by a user, while further hardware changes may potentially require further, specialized training and/or can be an additional source of error.

In particular, the injection valve may be the same for all three injection setups. That is, the injection valve may not be modified, i.e. it may remain identical for all injection setups.

The injection valve, the metering device, the separation column, the solvent pump, the waste, the at least one washing pump, the sample pickup means and the seat may be the same for each of the three injection setups (S₁, S₂, S₃). Again, avoiding any hardware modifications may advantageously allow the system to be operated and changed between injection setups by a broader range of users, which may not require any specialized training beyond changing of fluidic connections.

The method may comprise switching between the three injection setups S₁, S₂, S₃. Further, switching between injection setups may merely comprise reconfiguring fluidic connections between system components and optionally exchanging the sample loop. It will be understood that exchanging the sample loop may for example be desired when switching to a pushed-loop injection in order to account for a desired sample volume. However, since a sample loop may typically be a capillary, it may generally be the same as changing fluidic connections. Furthermore, it will be understood that reconfiguring fluidic connections may additionally comprise an input by a user indicating that the injection setup has been switched and how, e.g. a chromatographic software utilized for setting up, running and/or controlling the system may receive a respective input may a user. In particular, reconfiguring fluidic connections between system components and optionally exchanging the sample loop may comprise providing information about the changes to the system. Such information may for example be provided to the system via a graphical user interface.

Operating the system in any one of the three injection setups may comprise injecting a sample stored in the sample loop into the separation column. That is, a sample which may have previously been stored in the sample loop may be injected into the separation column for analysis. In other words, a sample stored in the sample loop may be transported to the separation column, where it may be chromatographically separated and analysed.

Injecting a sample may comprise the system assuming a respective injection configuration C_{I} in the respective injection setup. It will be understood that “the respective setup” may refer to the first injection setup S₁ the second injection setup S₂ or the third injection setup S₃.

The analytical path may comprise the sample loop, the sample pickup means, the seat and the metering device when assuming the injection configuration C_{I} while operating the system in the first injection setup S₁. It will be understood that also at least part of the injection valve may be comprised in the analytical path since the injection valve serves to establish the fluidic connections between components. Thus, the first injection setup may generally allow for a split-loop injection, wherein the metering device is comprised by the analytical path. The valve may be a valve according to any of the valve embodiments described herein, and assuming the injection configuration C_{I} while operating the system in the first injection setup S₁ may comprise the injection valve assuming the first valve position.

The analytical path may comprise the sample loop, the sample pickup means and the seat, but not the metering device, when assuming the injection configuration C_{I} while operating the system in the second injection setup S₂. Thus, the second injection setup may generally allow for a split-loop injection without the metering device being comprised by the analytical path, which may advantageously reduce the GDV. The valve may be a valve according to any of the valve embodiments described herein, wherein assuming the injection configuration C_{I} while operating the system in the second injection setup S₂ may comprise the injection valve assuming the first valve position.

The analytical path may comprise the sample loop, but not the sample pickup means, the seat and the metering device, when assuming the injection configuration C_{I} while operating in the third injection setup S₃. Thus, the second injection setup may generally allow for a pushed-loop injection (alternatively for example a pulled-loop injection). The valve may be a valve according to any of the valve embodiments described herein, wherein the valve comprises the second valve position, and wherein assuming the injection configuration C_{I} while operating the system in the third injection setup S₃ may comprise the injection valve assuming the second valve position.

Operating the system in any one of the three injection setups may comprise equilibrating the separation column with solvent provided by the solvent pump. Equilibrating the separation column may comprise the system assuming a respective equilibration configuration C_{E} in the respective injection setup, wherein the solvent pump is fluidly connected to the separation column without the sample loop, the sample pickup means, the seat or the metering device being part of said fluidic connection.

The method may further comprise washing the sample loop, the seat, the sample pickup means and the metering device using the at least one washing pump in parallel to equilibrating the separation column.

Operating the system in any one of the three injection setups may comprise picking up a sample using the metering device and the sample pickup means. Picking up the sample may comprise the system assuming a respective sample pickup configuration C_{P} in the respective injection setup, wherein a first device connection of the metering device is fluidly connected to the sample pickup means and a second device connection of the metering device is fluidly connected to a dead end, and wherein the sample pickup means is separated from the seat and moved to a sample vial. The method may further comprise the solvent pump providing a solvent to the separation column while picking up sample. The step of picking up the sample may comprise drawing in at least a portion of sample from a sample vial through the sample pickup means by means of the metering device.

Operating the system in any one of the three injection setups may comprise storing the sample in the sample loop. The sample may be directly sucked into and stored in the sample loop directly fluidly attached to the sample pickup means when operating the system in the first injection setup S₁ or the second injection setup S₂. Storing the sample in the sample loop may comprise pushing at least a portion of the picked-up sample into the sample loop by means of the metering device when operating the system in the third injection setup S₃. The method may comprise assuming the equilibration configuration S₃-C_{E} when storing the sample in the sample loop when operating the system in the third injection setup S₃.

The steps of picking up the sample and storing it may comprise repeatedly drawing in a portion of sample from a sample vial and storing it in the sample loop, with interrupted removal of solvent from the metering device. It will be understood that in the third injection setup the solvent is removed from the metering device when pushing the sample into the sample loop, while it may be separately drained from the metering device in the first and second injection setup.

Operating the system in any one of the three injection setups may comprise pressurizing the sample in the sample loop. Pressurizing the sample may comprise the system assuming a respective sample precompression configuration C_{C} in the respective injection setup, wherein a first device connection and a second device connection of the metering device are both fluidly connected to a dead end, and wherein one of said fluidic connections comprises the sample loop.

Operating the system in any one of the three injection setups may comprise depressurizing the sample loop and the metering device. Depressurizing the sample loop and the metering device may comprise assuming the sample precompression configuration C_{C}.

Operating the system in any one of the three injection setups may comprise washing an outer portion of the sample pickup means. Washing the outer portion of the sample pickup means may comprise the system assuming a respective pickup wash configuration C_{WP} in the respective injection setup, wherein the sample pickup means is fluidly detached from the seat while at least a tip of the sample pickup means remains within an inner volume of the seat, and wherein the at least one washing pump provides a solvent to the seat.

Operating the system in the second injection setup S₂ or in the third injection setup S₃ may comprise depressurizing the metering device, preferably down to ambient pressure. Depressurizing the metering device may comprise the system assuming a respective metering device compression configuration C_{MC} in the respective injection setup, wherein a first device connection and a second device connection of the metering device are both fluidly connected to a respective dead end, without the sample loop, or the separation column being comprised by said fluidic connections.

Operating the system in the second injection setup S₂ or in the third injection setup S₃ may comprise pressurizing the metering device, preferably to system pressure. Pressurizing the metering device may comprise the system assuming the respective metering device compression configuration C_{MC}.

Operating the system in the third injection setup S₃ may comprise washing the sample pickup means, the seat and the metering device using the at least one washing pump during the step of injecting the sample.

Operating the system in any one of the three injection setups may comprise purging the pump. Purging the pump may comprise the system assuming a respective pump purge configuration C_{PP} in the respective injection setup, wherein the solvent pump is fluidly connected to waste without the metering device, the sample loop, the sample pickup means, the seat or the separation column being part of said fluidic connection.

Operating the system in any one of the three injection setups may comprise purging the metering device. Purging the metering device may comprise the system assuming a respective metering device purge configuration C_{PM} in the respective injection setup, wherein the metering device is fluidly connected to the solvent pump and to either one of the waste or the sample pick up means, allowing the solvent pump to purge the metering device.

Operating the system in any one of the three injection setups may comprise performing system diagnostics to detect leaks within the system.

Performing system diagnostics may comprise leak testing the solvent pump. Leak testing the solvent pump may comprise the system assuming a respective pump leak test configuration C_{LP}, wherein the solvent pump is fluidly connected to a dead end without the separation column, the metering device, the sample loop, the sample pickup means or the seat being part of said fluidic connection.

Performing system diagnostics when operating in the first injection setup S₁ or in the third injection setup S₃ may comprise leak testing a sample handling portion of the system. Leak testing the sample handling portion of the system may comprise assuming a system leak test configuration C_{LS}, wherein the solvent pump is fluidly connected to a dead end and wherein said fluidic connection comprises the metering device, the sample pickup means and the seat, but not the separation column.

Performing system diagnostics when operating in the first injection setup S₁ or in the second injection setup S₂ may comprise leak testing the metering device. Leak testing the metering device may comprise assuming a metering device leak test configuration C_{LM}, wherein the solvent pump is fluidly connected to a dead end and wherein said fluidic connection comprises the metering device, but not the sample pickup means and the seat, or the separation column.

Performing system diagnostics when operating in the first injection setup S₁ or in the second injection setup S₂ may comprise leak testing the sample loop, the sample pickup means and the seat. Leak testing the sample pickup means and the seat may comprise assuming a pickup means leak test configuration C_{LSP}, wherein the solvent pump is fluidly connected to a dead end and wherein said fluidic connection comprises the sample loop, the sample pickup means and the seat, but not the metering device or the separation column.

In particular, operating the system in any one of the three injection setups may comprise the following steps in chronological order:
equilibrating the separation column with solvent provided by the solvent pump;
picking up a sample using the metering device and the sample pickup means;
storing the sample in the sample loop;
pressurizing the sample in the sample loop;
injecting the sample stored in the sample loop into the separation column; and
depressurizing the sample loop and the metering device.

Further, operating the system in the first injection setup S₁ may comprise washing an outer portion of the sample pickup means after picking up and storing the sample. Operating the system in the second injection setup S₂ may comprise washing an outer portion of the sample pickup means prior to the step of picking up the sample. Operating the system in the third injection setup S₃ may comprise washing an outer portion of the sample pickup means during or following the step of injecting the sample.

Operating the system in the second injection setup S₂ or in the third injection setup S₃ may further comprise depressurizing the metering device after pressurizing the sample and prior to injecting the sample; and pressurizing the metering device after injecting the sample and prior to depressurizing the sample loop and the metering device.

The method may comprise the solvent pump uninterruptedly providing a fluid flow to the separation column starting with the step of equilibrating the separation column and up finishing the step of pressurizing the sample in the sample loop.

The injection valve may be a valve according to any of the valve embodiments described herein.

In another embodiment, the present invention relates to a chromatography system comprising an injection valve comprising at least 8 ports, a metering device comprising a first device connection and a second device connection, a separation column, a solvent pump, a sample loop, a waste, at least one washing pump, and a sample pick-up means and a seat for receiving the sample pick-up means; wherein the system is configured to be operated in a first injection setup S₁, a second injection setup S₂ and a third injection setup S₃, wherein in each injection setup, different system components are comprised in an analytical path between the solvent pump and the separation column during sample injection.

The system may comprise the same hardware in all three injection setups, with the optional exception of a different sample loop, and wherein the three injection setups differ in the fluidic connections between system components. Again, it will be understood that the sample loop may typically only be a capillary, which may also be exchanged to adjust the volume of the sample loop to a desired volume for a full loop injection or multidraw procedure.

The system in the first injection setup S₁ may be configured for split-loop injection with adjustable gradient delay volume. That is, the fluidic volume of the analytical path may be adjustable, preferably by means of the metering device being comprised by the analytical path. This may for example advantageously allow to emulate analysis runs performed on other chromatographic systems.

The system in the second injection setup S₂ may be configured for split-loop injection with a fixed gradient delay volume, which is lower than in the first injection setup S₁. Thus, the overall GDV may be reduced in comparison to the first injection setup.

The system in the third injection setup S₃ may be configured for a pushed-loop injection and/or a pulled-loop injection with a fixed gradient delay volume, such as a full-loop injection and/or a partial-loop injection. The pulled-loop injection may be preferred over the pulled-loop injection due to its superior loading time, i.e. loading the sample may be significantly faster using pushed-loop injection.

The system may be configured to assume a respective injection configuration C_{I} in each of the three injection setups, wherein the analytical path comprises the sample loop. Generally, the injection configuration C_{I} may be configured for injecting a sample.

In the injection configuration of the first injection setup S₁-C_{I} the analytical path may comprise the sample loop, the sample pickup means, the seat and the metering device. The analytical path comprising the sample loop may advantageously allow to change the GDV of the analytical path. In the injection configuration of the first injection setup S₁-C_{I} the at least one washing pump may be fluidly connected to waste. The injection valve may be a valve according to any of the valve embodiments described herein, and wherein in the injection configuration of the first injection setup S₁-C_{I} the injection valve may assume the first valve position.

In the injection configuration of the second injection setup S₂-C_{I} the analytical path may comprise the sample loop, the sample pickup means and the seat, but not the metering device. This may advantageously allow to reduce the GDV of the analytical path compared to the first injection setup. In the injection configuration of the second injection setup S₂-C_{I} the at least one washing pump may be fluidly connected to waste, wherein said fluidic connection may comprise the metering device. The injection valve may be a valve according to any of the valve embodiments described herein, and wherein in the injection configuration of the second injection setup S₂-C_{I} the injection valve assumes the first valve position.

In the injection configuration of the third injection setup S₃-C_{I} the analytical path comprises the sample loop, but not the sample pickup means and the seat, or the metering device. This may advantageously allow for a pushed-loop injection or also a pulled-loop injection.

In the injection configuration of the third injection setup S₃-C_{I} the at least one washing pump may be fluidly connected to waste, wherein said fluidic connection may comprise the metering device, the seat and the sample pickup means. The injection valve may be a valve according to any of the valve embodiments described wherein the valve is configured to assume the second valve position, and wherein in the injection configuration of the third injection setup S₃-C_{I} the injection valve may assume the second valve position.

In the respective injection configuration C_{I} of any one of the three injection setups the analytical path may be dead-volume free within the injection valve and preferably between the solvent pump and the separation column.

The system may be configured to assume a respective equilibration configuration C_{E} in each of the three injection setups, wherein the solvent pump is fluidly connected to the separation column without the sample loop, the sample pickup means, the seat or the metering device being part of said fluidic connection. Said fluidic connection between the solvent pump and the separation column may be dead-volume free within the injection valve and preferably between the solvent pump and the separation column.

In the respective equilibration configuration C_{E} of any one of the three injection setups, the at least one washing pump may be fluidly connected to waste, wherein said fluidic connection may comprise the seat, the sample pickup means, the sample loop, and the metering device. Said fluidic connection between the at least one washing pump and waste may be dead-volume free within the injection valve and preferably between the at least one washing pump and the waste.

The system may be configured to assume a respective sample pickup configuration C_{P} in each of the three injection setups, wherein the first device connection of the metering device is fluidly connected to the sample pickup means and the second device connection of the metering device is fluidly connected to a dead end, and wherein the sample pickup means is separated from the seat and moved to a sample vial. In the respective sample pickup configuration C_{P} the solvent pump may be fluidly connected to the separation column. Preferably, the system may be configured such that the solvent pump remains fluidly connected to the separation column when switching from the injection configuration C_{I} to the equilibration configuration C_{I} in any one of the three injection setups.

In the respective sample pickup configuration C_{P} of the first injection setup S₁ and of the second injection setup S₂ the sample loop may be comprised in the fluidic connection of the first device connection to the sample pickup means.

In the respective sample pickup configuration C_{P} of the third injection setup S₃ the sample loop may not be comprised in the fluidic connection of the first device connection to the sample pickup means.

The system may be configured to assume a respective precompression configuration C_{C} in each of the three injection setups, wherein the first device connection and the second device connection are fluidly connected to a dead end and wherein one of said fluidic connections comprises the sample loop. In the respective precompression configuration C_{C} the solvent pump may be fluidly connected to the separation column. Preferably, the system may be configured such that the solvent pump remains fluidly connected to the separation column when switching from the sample pickup configuration C_{P} to the equilibration configuration C_{E} in any one of the three injection setups.

The system may be configured to assume a respective pickup wash configuration C_{WP} in each of the three injection setups, wherein the sample pickup means is fluidly detached from the seat while at least a tip of the sample pickup means remains within an inner volume of the seat, and wherein the at least one washing pump is fluidly connected to the seat.

The system may be configured to assume a respective metering device compression configuration C_{MC} in the second injection setup S₂ or the third injection setup S₃, wherein both connections of the metering device are fluidly connected to a respective dead end, without the sample loop or the separation column being comprised by said fluidic connections.

The system may be configured to assume a respective pump purge configuration C_{PP} in each of the three injection setups, wherein the solvent pump is fluidly connected to waste without the metering device, the sample loop, the sample pickup means, the seat or the separation column being part of said fluidic connection.

The system may be configured to assume a respective metering device purge configuration C_{PM} in each of the three injection setups, wherein the metering device is fluidly connected to the solvent pump and to either one of the waste or the sample pick up means, allowing the solvent pump to purge the metering device.

The system may be configured to assume a respective pump leak test configuration C_{LP} in each of the three injection setups, wherein the solvent pump is fluidly connected to a dead end without the separation column, the metering device, the sample loop, the sample pickup means or the seat being part of said fluidic connection.

The system may be configured to assume a respective system leak test configuration C_{LS} in the first injection setup S₁ and in the third injection setup S₃, wherein the solvent pump is fluidly connected to a dead end and wherein said fluidic connection comprises the metering device, the sample pickup means and the seat, but not the separation column.

The system may be configured to assume a respective pickup means leak test configuration C_{LSP} in the first injection setup S₁ and in the second injection setup S₂, wherein the solvent pump is fluidly connected to a dead end and wherein said fluidic connection comprises the sample pickup means, and the seat, but not the metering device, or the separation column.

The system may be configured to assume a respective metering device leak test configuration C_{LM} in the first injection setup S₁ and in the second injection setup S₂, wherein the solvent pump is fluidly connected to a dead end and wherein said fluidic connection comprises the metering device, but not the sample pickup means, the seat, or the separation column.

The system may further comprise a check valve fluidly connected to the at least one washing pump and configured to prevent flow from other parts of the system towards the at least one washing pump. That is, the check valve may protect the at least one washing pump from system pressures, which may be too high for the at least one washing pump.

The injection valve may comprise at least four connecting elements. Preferably, the injection valve may comprise exactly four connecting elements. The injection valve may be a shear valve comprising a rotor and a stator. The at least 8 ports may be comprised by the stator. A first port may be located at a centre of the stator, while the remaining 7 ports may be located equally spaced in a circumferential direction on a circle around the first port. A first connecting element may be generally hook-shaped and dimensioned such that it can fluidly connect the first port to each of the other ports, respectively. The second and third connecting element may comprise the shape of an arc oriented along the circle and dimensioned such that they can connect two neighbouring ports on the circle without any dead volume in said connection. The fourth connecting element may comprise a shape that allows to connect two neighbouring outer ports on the circle both with or without dead volume. That is, the fourth connecting element may allow to selectively connect two neighbouring outer ports either without or with dead volume being present in the fourth connecting element. The at least four connecting elements may be provided through grooves in the stator and/or rotor, preferably only in the rotor.

An outlet of the separation column may be fluidly connected to a detector, preferably a detector comprised by the system. The detector may be one of a charged aerosol detector (CAD), a mass spectrometer, a fluorescence detector, a refractive-index detector, an absorbance detector, or an evaporative-light-scattering detector.

In the first injection setup S₁,
the solvent pump may be directly fluidly connected to a first port;
the separation column may be directly fluidly connected to a second port;
the first device connection of the metering device may be directly fluidly connected to an eighth port;
the second device connection of the metering device may be directly fluidly connected to a sixth port;
a first end of the sample loop may be directly fluidly connected to a seventh port;
a second end of the sample loop may be directly fluidly connected to the sample pickup means;
the seat may be directly fluidly connected to a third port;
the at least one washing pump may be directly fluidly connected to a fourth port; and
the waste may be directly fluidly connected to a fifth port.
   In the second injection setup S₂
the solvent pump may be directly fluidly connected to a first port;
the separation column may be directly fluidly connected to a second port;
the first device connection of the metering device may be directly fluidly connected to a seventh port;
the second device connection of the metering device may be directly fluidly connected to a fifth port;
a first end of the sample loop may be directly fluidly connected to an eight port;
a second end of the sample loop may be directly fluidly connected to the sample pickup means;
the seat may be directly fluidly connected to a third port;
the at least one washing pump may be directly fluidly connected to a fourth port; and
the waste may be directly fluidly connected to a sixth port
   In the third injection setup S₃
the solvent pump may be directly fluidly connected to a first port;
the separation column may be directly fluidly connected to a fifth port;
the first device connection of the metering device may be directly fluidly connected the sample pickup means;
the second device connection of the metering device may be directly fluidly connected to an eighth port;
a first end of the sample loop may be directly fluidly connected to a fourth port;
a second end of the sample loop may be directly fluidly connected to a sixth port;
the seat may be directly fluidly connected to a third port;
the at least one washing pump may be directly fluidly connected to a second port; and
the waste may be directly fluidly connected to a seventh port

The system may comprise a controller configured to control the system. The controller may be configured to operate the chromatography system according to any of the preceding method embodiments.

The injection valve may be a valve according to any of the valve embodiments described herein.

For the method embodiments described herein, the chromatography system may be a chromatography system according to any of the system embodiments described herein (e.g., above).

In another embodiment, the present invention relates to a computer program product comprising instructions which, when the program is executed by the controller of a chromatography system according to the system embodiments described herein, cause the controller to operate the chromatography system according to any of the preceding method embodiments described herein.

Below, reference will be made to valve embodiments. These embodiments are abbreviated by the letter “V” followed by a number. Whenever reference is herein made to “valve embodiments”, these embodiments are meant.

V1. A valve for a liquid chromatography system,
wherein the valve comprises at least 8 ports, wherein the at least 8 ports comprise a first port (102), a second port (104), a third port (106), a fourth port (108), a fifth port (110), a sixth port (112), a seventh port (114), and an eighth port (116);
wherein the valve comprises at least 4 connecting elements for connecting the ports, wherein the at least 4 connecting elements comprise a first connecting element (120), a second connecting element (122), a third connecting element (124), and a fourth connecting element (128);
wherein the valve is configured to assume a first valve position, wherein the first connecting element (120) connects the first port (102) and the eighth port (116) free of dead volume, wherein the second connecting element (122) connects the second port (104) and the third port (106) free of dead volume, wherein the third connecting element (124) connects the fourth port (108) and the fifth port (110) free of dead volume, and wherein the fourth connecting element (126) connects the sixth port (112) and the seventh port (114) free of dead volume.

It will be understood that a valve position generally refers to a relative position of connecting elements and ports of the valve. For example, in case of a shear valve comprising a stator and a rotor, a valve position may be determined by the relative position of stator and rotor. Thus, each valve position corresponds to a respective configuration of the valve and may also be referred to as valve configuration.

V2. The valve according to the preceding valve embodiment,
wherein the valve is configured to assume a second valve position, wherein the first connecting element (120) connects the first port (102) and the fourth port (108) free of dead volume, wherein the second connecting element (122) connects the fifth port (110) and the sixth port (112) free of dead volume, wherein the third connecting element (124) connects the seventh port (114) and the eighth port (116) free of dead volume, and wherein the fourth connecting element (126) connects the second port (104) and the third port (106) free of dead volume.
   V3. The valve according to any of the preceding valve embodiments,
wherein the valve is configured to assume a third valve position, wherein the first connecting element (120) connects the first port (102) and the second port (104) free of dead volume, wherein the second connecting element (122) connects the third port (106) and the fourth port (108) free of dead volume, wherein the third connecting element (124) connects the fifth port (110) and the sixth port (112) free of dead volume, and wherein the fourth connecting element (126) connects the seventh port (114) and the eighth port (116) free of dead volume.
   V4. The valve according to any of the preceding valve embodiments,
wherein the valve is configured to assume a fourth valve position, wherein the first connecting element (120) connects the first port (102) and the fifth port (110) free of dead volume, wherein the second connecting element (122) connects the sixth port (112) and the seventh port (114) free of dead volume, wherein the third connecting element (124) connects the eighth port (116) and the second port (104) free of dead volume, and wherein the fourth connecting element (126) connects the third port (106) and the fourth port (108) free of dead volume.
   V5. The valve according to any of the preceding valve embodiments,
wherein the valve is configured to assume a fifth valve position, wherein the first connecting element (120) connects the first port (102) and the second port (104) with dead volume being present in the first connecting element (120), wherein the second connecting element (122) is only connected to the third port (106), wherein the third connecting element (124) is only connected to the fifth port (110), wherein the fourth connecting element (126) connects the seventh port (114) and the eighth port (116) with dead volume being present in the fourth connecting element (126), and wherein the fourth port (108) and the sixth port (112) are not connected to any of the four connecting elements.
   V6. The valve according to any of the preceding valve embodiments,
wherein the valve is configured to assume a sixth valve position, wherein the first connecting element (120) connects the first port (102) and the fifth port (110) with dead volume being present in the first connecting element (120), wherein the second connecting element (122) is only connected to the sixth port (112), wherein the third connecting element (124) is only connected to the eighth port (116), wherein the fourth connecting element (126) is not connected to any of the 8 ports, and wherein the second port (104), third port (106), the fourth port (108) and the seventh port (114) are not connected to any of the four connecting elements.
   V7. The valve according to any of the preceding valve embodiments,
wherein the valve is configured to assume a seventh valve position, wherein the first connecting element (120) connects the first port (102) and the fifth port (110) with dead volume being present in the first connecting element (120), wherein the second connecting element (122) is only connected to the sixth port (112), wherein the third connecting element (124) is only connected to the eighth port (116), wherein the fourth connecting element (126) connects the third port (106) and the fourth port (108) with dead volume being present in the fourth connecting element (126), and wherein the second port (102), and the seventh port (114) are not connected to any of the four connecting elements.
   V8. The valve according to any of the preceding valve embodiments,
wherein the valve is configured to assume an eighth valve position, wherein the first connecting element (120) is only connected to the first port (102), wherein the second connecting element (122) is only connected to the fourth port (108), wherein the third connecting element (124) is only connected to the sixth port (112), wherein the fourth connecting element (126) is not connected to any of the 8 ports, and wherein the second port (104), third port (106), the fifth port (110), the seventh port (114) and the eight port (116) are not connected to any of the four connecting elements.
   V9. The valve according to any of the preceding valve embodiments,
   wherein the valve is configured to assume a ninth valve position, wherein the first connecting element (120) connects the first port (102) and the eighth port (116) with dead volume being present in the first connecting element (120), wherein the second connecting element (122) is only connected to the second port (104), wherein the third connecting element (124) is only connected to the fourth port (108), wherein the fourth connecting element (126) connects the sixth port (112) and the seventh port (114) with dead volume being present in the fourth connecting element (126), and wherein the third port (106) and the fifth port (110) are not connected to any of the four connecting element.
   V10. The valve according to any of the preceding valve embodiments,
   wherein the valve is configured to assume a tenth valve position, wherein the first connecting element (120) connects the first port (102) and the sixth port (112) with dead volume being present in the first connecting element (120), wherein the second connecting element (122) is only connected to the seventh port (114), wherein the third connecting element (124) is only connected to the second port (104), wherein the fourth connecting element (126) is not connected to any of the 8 ports, and wherein the third port (106), the fourth port (108), the fifth port (110), and the eight port (116) are not connected to any of the four connecting elements.
   V11. The valve according to any of the preceding valve embodiments,
   wherein the valve is configured to assume an eleventh valve position, wherein the first connecting element (120) connects the first port (102) and the seventh port (114) with dead volume being present in the first connecting element (120), wherein the second connecting element (122) is only connected to the eighth port (116), wherein the third connecting element (124) is only connected to the third port (106), wherein the fourth connecting element (126) is not connected to any of the 8 ports, and wherein the second port (104), the fourth port (108), the fifth port (110), and the sixth port (112) are not connected to any of the four connecting elements.
   V12. The valve according to any of the preceding valve embodiments,
   wherein the valve is configured to assume a twelfth valve position, wherein the first connecting element (120) connects the first port (102) and the sixth port (112) free of dead volume, wherein the second connecting element (122) connects the seventh port (114) and the eighth port (116) free of dead volume, wherein the third connecting element (124) connects the second port (104) and the third port (106) free of dead volume, and wherein the fourth connecting element (126) connects the fourth port (108) and the fifth port (110) free of dead volume.
   V13. The valve according to any of the preceding valve embodiments,
wherein the valve is configured to assume a thirteenth valve position, wherein the first connecting element (120) connects the first port (102) and the second port (104) with dead volume being present in the first connecting element (120), wherein the second connecting element (122) is only connected to the third port (106), wherein the third connecting element (124) is only connected to the fifth port (110), wherein the fourth connecting element (126) is not connected to any of the 8 ports, and wherein the fourth port (108), the sixth port (112), the seventh port (114), and the eighth port (116) are not connected to any of the four connecting elements.
   V14. The valve according to any of the preceding valve embodiments,
wherein the valve is configured to assume a fourteenth valve position, wherein the first connecting element (120) is only connected to the first port (102), wherein the second connecting element (122) is only connected to the third port (106), wherein the third connecting element (124) is only connected to the fifth port (110), wherein the fourth connecting element (126) is not connected to any of the 8 ports, and wherein the second port (104), fourth port (108), the sixth port (112), the seventh port (114), and the eighth port (116) are not connected to any of the four connecting elements.
   V15. The valve according to any of the preceding valve embodiments,
wherein the valve is configured to assume a fifteenth valve position, wherein the first connecting element (120) connects the first port (102) and the eighth port (116) with dead volume being present in the first connecting element (120), wherein the second connecting element (122) is only connected to the second port (104), wherein the third connecting element (124) is only connected to the fourth port (108), wherein the fourth connecting element (126) is not connected to any of the 8 ports, and wherein the third port (106), the fifth port (110), the sixth port (112), and the seventh port (114) are not connected to any of the four connecting elements.
   V16. The valve according to any of the preceding valve embodiments,
wherein the valve is configured to assume a sixteenth valve position, wherein the first connecting element (120) connects the first port (102) and the seventh port (114) free of dead volume, wherein the second connecting element (122) connects the eighth port (116) and the second port (104) free of dead volume, wherein the third connecting element (124) connects the third port (106) and the fourth port (108) free of dead volume, and wherein the fourth connecting element (126) connects the fifth port (110) and the sixth port (112) free of dead volume.
   V17. The valve according to any of the preceding valve embodiments, wherein the valve is a shear valve comprising a rotor and a stator.
   V18. The valve according to the preceding valve embodiment, wherein the at least 8 ports are comprised by the stator.
   V19. The valve according to any of the 2 preceding valve embodiments, wherein the first port is located at a centre of the stator, while the remaining 7 ports are located equally spaced in a circumferential direction on a circle around the first port.
   V20. The valve according to any of the 3 preceding valve embodiments, wherein the at least 4 connecting elements are located in the stator and/or rotor, preferably only in the rotor.
   V21. The valve according to any of the 4 preceding valve embodiments, wherein the at least 4 connecting elements are provided through grooves in the stator and/or rotor, preferably only in the rotor.
   V22. The valve according to any of the preceding valve embodiments, wherein the first connecting element is generally hook-shaped and dimensioned such that it can fluidly connect the first port to each of the other ports, respectively.
   V23. The valve according to any of the preceding valve embodiments and with the features of V19, wherein the second and third connecting element comprise the shape of an arc oriented along the circle and dimensioned such that they can connect two neighbouring ports on the circle without any dead volume in said connection.
   V24. The valve according to any of the preceding valve embodiments and with the features of V19, wherein the fourth connecting element comprises a shape that allows to connect two neighbouring ports on the circle both with or without dead volume.
   V25. The valve according to any of the preceding valve embodiments, wherein each of the ports is point shaped.

Below, reference will be made to method embodiments. These embodiments are abbreviated by the letter “M” followed by a number. Whenever reference is herein made to “method embodiments”, these embodiments are meant.

M1. Method for operating a chromatography system, wherein the chromatography system (1) comprises an injection valve (10) comprising at least 8 ports (102, 104, 106, 108, 110, 112, 114, 116), a metering device (40), a separation column (30), a solvent pump (20), a sample loop (50), a waste (70), at least one washing pump (80), and a sample pickup means (62) and a seat (64) for receiving the sample pick-up means;
the method comprising
operating the chromatography system in a first injection setup S₁, a second injection setup S₂ and a third injection setup S₃, wherein in each injection setup, different system components are comprised in an analytical path between the solvent pump (20) and the separation column (30) during sample injection.
   M2. The method according to the preceding method embodiment, wherein changing between different injection setups (S₁, S₂, S₃) does not require any hardware modifications other than changing fluidic connections between system components and optionally changing the sample loop.

That is, no parts or portions of the system need to be exchanged, e.g. the rotor may remain the same for all injection setups, and merely fluidic connections may be swapped and changed. It will be understood that the sample loop, which may typically be a capillary, may optionally be exchanged, particularly when operating in the third injection setup to comprise a desired volume for a full loop injection.

M3. The method according to any of the preceding method embodiments, wherein the injection valve is the same for all three injection setups.
M4. The method according to any of the preceding method embodiments, wherein the injection valve (10), the metering device (40), the separation column (30), the solvent pump (20), the waste (70), the at least one washing pump (80), the sample pickup means (62) and the seat (64) are the same for each of the three injection setups (S₁, S₂, S₃).
M5. The method according to any of the preceding method embodiments, wherein the method comprises switching between the three injection setups S₁, S₂, S₃.
M6. The method according to the preceding method embodiment, wherein switching between injection setups merely comprises reconfiguring fluidic connections between system components and optionally exchanging the sample loop.
M7. The method according to any of the preceding method embodiments, wherein operating the system in any one of the three injection setups comprises
injecting a sample stored in the sample loop into the separation column.
   M8. The method according to the preceding method embodiment, wherein injecting a sample comprises the system assuming a respective injection configuration C_{I} in the respective injection setup.
   M9. The method according to the preceding method embodiment, wherein the analytical path comprises the sample loop (50), the sample pickup means (62), the seat (64) and the metering device (40) when assuming the injection configuration C_{I} while operating the system in the first injection setup S₁.

It will be understood that also at least part of the injection valve (10) is comprised in the analytical path since the injection valve (10) serves to establish the fluidic connections between components.

M10. The method according to the preceding method embodiment, wherein the valve is a valve according to any of the preceding valve embodiments, and wherein assuming the injection configuration C_{I} while operating the system in the first injection setup S₁ comprises the injection valve assuming the first valve position.
M11. The method according to any of the 3 preceding method embodiments, wherein the analytical path comprises the sample loop (50), the sample pickup means (62) and the seat (64), but not the metering device (40), when assuming the injection configuration C_{I} while operating the system in the second injection setup S₂.
M12. The method according to the preceding method embodiment, wherein the valve is a valve according to any of the preceding valve embodiments, wherein assuming the injection configuration C_{I} while operating the system in the second injection setup S₂ comprises the injection valve assuming the first valve position.
M13. The method according to any of the 5 preceding method embodiments, wherein the analytical path comprises the sample loop (50), but not the sample pickup means (62), the seat (64) and the metering device (40), when assuming the injection configuration C_{I} while operating in the third injection setup S₃.
M14. The method according to the preceding method embodiment, wherein the valve is a valve according to any of the preceding valve embodiments with the features of V2, and wherein assuming the injection configuration C_{I} while operating the system in the third injection setup S₃ comprises the injection valve assuming the second valve position.
M15. The method according to any of the preceding method embodiments, wherein operating the system in any one of the three injection setups comprises
equilibrating the separation column with solvent provided by the solvent pump.
   M16. The method according to the preceding method embodiment, wherein equilibrating the separation column comprises the system assuming a respective equilibration configuration C_{E} in the respective injection setup, wherein the solvent pump is fluidly connected to the separation column without the sample loop, the sample pickup means, the seat or the metering device being part of said fluidic connection.
   M17. The method according to any of the 2 preceding method embodiments, wherein the method further comprises washing the sample loop, the seat, the sample pickup means and the metering device using the at least one washing pump in parallel to equilibrating the separation column.
   M18. The method according to any of the preceding method embodiments, wherein operating the system in any one of the three injection setups comprises
picking up a sample using the metering device and the sample pickup means.
   M19. The method according to the preceding method embodiment, wherein picking up the sample comprises the system assuming a respective sample pickup configuration C_{P} in the respective injection setup, wherein a first device connection of the metering device is fluidly connected to the sample pickup means and a second device connection of the metering device is fluidly connected to a dead end, and wherein the sample pickup means is separated from the seat and moved to a sample vial.
   M20. The method according to any of the 2 preceding method embodiments, wherein the method further comprises the solvent pump providing a solvent to the separation column while picking up sample.
   M21. The method according to any of the 3 preceding method embodiments, wherein the step of picking up the sample comprises drawing in at least a portion of sample from a sample vial through the sample pickup means by means of the metering device.
   M22. The method according to any of the 4 preceding method embodiments, wherein operating the system in any one of the three injection setups comprises
storing the sample_in the sample loop.
   M23. The method according to the preceding method embodiment, wherein the sample is directly sucked into and stored in the sample loop directly fluidly attached to the sample pickup means when operating the system in the first injection setup S₁ or the second injection setup S₂.
   M24. The method according to any of the 2 preceding method embodiments, wherein storing the sample in the sample loop comprises pushing at least a portion of the picked-up sample into the sample loop by means of the metering device when operating the system in the third injection setup S₃.
   M25. The method according to the preceding method embodiment and with the features of M13, wherein the method comprises assuming the equilibration configuration S₃-C_{E} when storing the sample in the sample loop when operating the system in the third injection setup S₃.
   M26. The method according to any of the 4 preceding method embodiments, wherein the steps of picking up the sample and storing it comprises repeatedly drawing in a portion of sample from a sample vial and storing it in the sample loop, with interrupted removal of solvent from the metering device.

It will be understood that in the third injection setup the solvent is removed from the metering device when pushing the sample into the sample loop, while it may be separately drained from the metering device in the first and second injection setup.

M27. The method according to any of the 5 preceding method embodiments, wherein operating the system in any one of the three injection setups comprises
pressurizing the sample in the sample loop.
   M28. The method according to the preceding method embodiment, wherein pressurizing the sample comprises the system assuming a respective sample precompression configuration C_{C} in the respective injection setup, wherein a first device connection and a second device connection of the metering device are both fluidly connected to a dead end, and wherein one of said fluidic connections comprises the sample loop.
   M29. The method according to any of the preceding method embodiments, wherein operating the system in any one of the three injection setups comprises
depressurizing the sample loop and the metering device.
   M30. The method according to the preceding method embodiment and with the features of M28, wherein depressurizing the sample loop and the metering device comprises assuming the sample precompression configuration C_{C}.
   M31. The method according to any of the preceding method embodiments, wherein operating the system in any one of the three injection setups comprises
washing an outer portion of the sample pickup means.
   M32. The method according to the preceding method embodiment, wherein washing the outer portion of the sample pickup means comprises the system assuming a respective pickup wash configuration C_{WP} in the respective injection setup, wherein the sample pickup means is fluidly detached from the seat while at least a tip of the sample pickup means remains within an inner volume of the seat, and wherein the at least one washing pump provides a solvent to the seat.
   M33. The method according to any of the preceding method embodiments, wherein operating the system in the second injection setup S₂ or in the third injection setup S₃ comprises
depressurizing the metering device, preferably down to ambient pressure.
   M34. The method according to the preceding method embodiment, wherein depressurizing the metering device comprises the system assuming a respective metering device compression configuration C_{MC} in the respective injection setup, wherein a first device connection and a second device connection of the metering device are both fluidly connected to a respective dead end, without the sample loop, or the separation column being comprised by said fluidic connections.
   M35. The method according to any of the 2 preceding method embodiments, wherein operating the system in the second injection setup S₂ or in the third injection setup S₃ comprises
pressurizing the metering device, preferably to system pressure.
   M36. The method according to the preceding method embodiment and with the features of M34, wherein pressurizing the metering device comprises the system assuming the respective metering device compression configuration C_{MC}.
   M37. The method according to any of the preceding method embodiments and with the features of M7, wherein operating the system in the third injection setup S₃ comprises
washing the sample pickup means, the seat and the metering device using the at least one washing pump during the step of injecting the sample.
   M38. The method according to any of the preceding method embodiments, wherein operating the system in any one of the three injection setups comprises purging the pump.
   M39. The method according to the preceding method embodiment, wherein purging the pump comprises the system assuming a respective pump purge configuration C_{PP} in the respective injection setup, wherein the solvent pump is fluidly connected to waste without the metering device, the sample loop, the sample pickup means, the seat or the separation column being part of said fluidic connection.
   M40. The method according to any of the preceding method embodiments, wherein operating the system in any one of the three injection setups comprises purging the metering device.
   M41. The method according to the preceding method embodiment, wherein purging the metering device comprises the system assuming a respective metering device purge configuration C_{PM} in the respective injection setup, wherein the metering device is fluidly connected to the solvent pump and to either one of the waste or the sample pick up means, allowing the solvent pump to purge the metering device.

M42. The method according to any of the preceding method embodiments, wherein operating the system in any one of the three injection setups comprises performing system diagnostics to detect leaks within the system.

M43. The method according to the preceding method embodiment, wherein performing system diagnostics comprises leak testing the solvent pump.

M44. The method according to the preceding method embodiment, wherein leak testing the solvent pump comprises the system assuming a respective pump leak test configuration C_{LP}, wherein the solvent pump is fluidly connected to a dead end without the separation column, the metering device, the sample loop, the sample pickup means or the seat being part of said fluidic connection.

M45. The method according to any of the 3 preceding method embodiments, wherein performing system diagnostics when operating in the first injection setup S₁ or in the third injection setup S₃ comprises leak testing a sample handling portion of the system.
M46. The method according to the preceding method embodiment, wherein leak testing the sample handling portion of the system comprises assuming a system leak test configuration C_{LS}, wherein the solvent pump is fluidly connected to a dead end and wherein said fluidic connection comprises the metering device, the sample pickup means and the seat, but not the separation column.
M47. The method according to any of the 5 preceding method embodiments, wherein performing system diagnostics when operating in the first injection setup S₁ or in the second injection setup S₂ comprises leak testing the metering device.
M48. The method according to the preceding method embodiment, wherein leak testing the metering device comprises assuming a metering device leak test configuration C_{LM}, wherein the solvent pump is fluidly connected to a dead end and wherein said fluidic connection comprises the metering device, but not the sample pickup means and the seat, or the separation column.
M49. The method according to any of the 7 preceding method embodiments, wherein performing system diagnostics when operating in the first injection setup S₁ or in the second injection setup S₂ comprises leak testing the sample loop, the sample pickup means and the seat.
M50. The method according to the preceding method embodiment, wherein leak testing the sample pickup means and the seat comprises assuming a pickup means leak test configuration C_{LSP}, wherein the solvent pump is fluidly connected to a dead end and wherein said fluidic connection comprises the sample loop, the sample pickup means and the seat, but not the metering device or the separation column.
M51. The method according to any of the preceding method embodiments and with the features of M7, M15, M18, M22, M27, and M29 wherein operating the system in any one of the three injection setups comprises the following steps in chronological order:
equilibrating the separation column with solvent provided by the solvent pump;
picking up a sample using the metering device and the sample pickup means;
storing the sample in the sample loop;
   pressurizing the sample in the sample loop;
   injecting the sample stored in the sample loop into the separation column; and
   depressurizing the sample loop and the metering device.
   M52. The method according to the preceding method embodiment and with the features of M31, wherein operating the system in the first injection setup S₁ further comprises
washing an outer portion of the sample pickup means after picking up and storing the sample.
   M53. The method according to any of the 2 preceding method embodiments and with the features of M31, wherein operating the system in the second injection setup S₂ further comprises
washing an outer portion of the sample pickup means prior to the step of picking up the sample.
   M54. The method according to any of the 3 preceding method embodiments and with the features of M31, wherein operating the system in the third injection setup S₃ further comprises
washing an outer portion of the sample pickup means during or following the step of injecting the sample.
   M55. The method according to any of the 4 preceding method embodiments and with the features of M33 and M35, wherein operating the system in the second injection setup S₂ or in the third injection setup S₃ further comprises
depressurizing the metering device after pressurizing the sample and prior to injecting the sample; and
pressurizing the metering device after injecting the sample and prior to depressurizing the sample loop and the metering device.
   M56. The method according to any of the 5 preceding method embodiments, wherein the method comprises the solvent pump uninterruptedly providing a fluid flow to the separation column starting with the step of equilibrating the separation column and up finishing the step of pressurizing the sample in the sample loop.
   M57. The method according to any of the preceding method embodiments, wherein the injection valve is a valve according to any of the preceding valve embodiments.
   M58. The method according to any of the preceding method embodiments and with the features of M6, wherein reconfiguring fluidic connections between system components and optionally exchanging the sample loop comprises providing information about the changes to the system.

Below, reference will be made to system embodiments. These embodiments are abbreviated by the letter “S” followed by a number. Whenever reference is herein made to “system embodiments”, these embodiments are meant.

S1. A chromatography system comprising
an injection valve (10) comprising at least 8 ports (102, 104, 106, 108, 110, 112, 114, 116),
a metering device (40) comprising a first device connection and a second device connection,
   a separation column (30),
a solvent pump (20),
a sample loop (50),
a waste (70),
at least one washing pump (80), and
a sample pick-up means (62) and a seat (64) for receiving the sample pick-up means;
   wherein the system is configured to be operated in a first injection setup S₁, a second injection setup S₂ and a third injection setup S₃, wherein in each injection setup, different system components are comprised in an analytical path between the solvent pump (20) and the separation column (30) during sample injection.
   S2. The system according to the preceding system embodiment, wherein the system comprises the same hardware in all three injection setups, with the optional exception of a different sample loop, and wherein the three injection setups differ in the fluidic connections between system components.

Again, it will be understood that the sample loop may typically only be a capillary, which may also be exchanged to adjust the volume of the sample loop to a desired volume for a full loop injection or multidraw procedure.

S3. The system according to any of the preceding system embodiments, wherein the system in the first injection setup S₁ is configured for split-loop injection with adjustable gradient delay volume.
S4. The system according to any of the preceding system embodiments, wherein the system in the second injection setup S₂ is configured for split-loop injection with a fixed gradient delay volume, which is lower than in the first injection setup S₁.
S5. The system according to any of the preceding system embodiments, wherein the system in the third injection setup S₃ is configured for a pushed-loop injection and/or a pulled-loop injection with a fixed gradient delay volume, such as a full-loop injection and/or a partial-loop injection.
S6. The system according to any of the preceding system embodiments, wherein the system is configured to assume a respective injection configuration C_{I} in each of the three injection setups, wherein the analytical path comprises the sample loop.
S7. The system according to the preceding system embodiment, wherein in the injection configuration of the first injection setup S₁-C_{I} the analytical path comprises the sample loop, the sample pickup means, the seat and the metering device.
S8. The system according to the preceding system embodiment, wherein in the injection configuration of the first injection setup S₁-C_{I} the at least one washing pump is fluidly connected to waste.
S8a. The system according to any of the 3 preceding system embodiments, wherein the injection valve is a valve according to any of the preceding valve embodiments, and wherein in the injection configuration of the first injection setup S₁-C_{I} the injection valve assumes the first valve position.
S9. The system according to any of the 4 preceding system embodiments, wherein in the injection configuration of the second injection setup S₂-C_{I} the analytical path comprises the sample loop, the sample pickup means and the seat, but not the metering device.
S10. The system according to the preceding system embodiment, wherein in the injection configuration of the second injection setup S₂-C_{I} the at least one washing pump is fluidly connected to waste, wherein said fluidic connection comprises the metering device.
S10a. The system according to any of the 6 preceding system embodiments, wherein the injection valve is a valve according to any of the preceding valve embodiments, and wherein in the injection configuration of the second injection setup S₂-C_{I} the injection valve assumes the first valve position.
S11. The system according to any of the 7 preceding system embodiments, wherein in the injection configuration of the third injection setup S₃-C_{I} the analytical path comprises the sample loop, but not the sample pickup means and the seat, or the metering device.
S12. The system according to the preceding system embodiment, wherein in the injection configuration of the third injection setup S₃-C_{I} the at least one washing pump is fluidly connected to waste, wherein said fluidic connection comprises the metering device, the seat and the sample pickup means.
S12a. The system according to any of the 9 preceding system embodiments, wherein the injection valve is a valve according to any of the preceding valve embodiments with the features of V2, and wherein in the injection configuration of the third injection setup S₃-C_{I} the injection valve assumes the second valve position.
S13. The system according to any of the 10 preceding system embodiments, wherein in the respective injection configuration C_{I} of any one of the three injection setups the analytical path is dead-volume free within the injection valve and preferably between the solvent pump and the separation column.
S14. The system according to any of the preceding system embodiments, wherein the system is configured to assume a respective equilibration configuration C_{E} in each of the three injection setups, wherein the solvent pump is fluidly connected to the separation column without the sample loop, the sample pickup means, the seat or the metering device being part of said fluidic connection.
S15. The system according to the preceding system embodiment, wherein said fluidic connection between the solvent pump and the separation column is dead-volume free within the injection valve and preferably between the solvent pump and the separation column.
S16. The system according to any of the 2 preceding system embodiments, wherein in the respective equilibration configuration C_{E} of any one of the three injection setups, the at least one washing pump is fluidly connected to waste, wherein said fluidic connection comprises the seat, the sample pickup means, the sample loop, and the metering device.
S17. The system according to the preceding system embodiment, wherein said fluidic connection between the at least one washing pump and waste is dead-volume free within the injection valve and preferably between the at least one washing pump and the waste.
S18. The system according to any of the preceding system embodiments, wherein the system is configured to assume a respective sample pickup configuration C_{P} in each of the three injection setups, wherein the first device connection of the metering device is fluidly connected to the sample pickup means and the second device connection of the metering device is fluidly connected to a dead end, and wherein the sample pickup means is separated from the seat and moved to a sample vial.
S19. The system according to the preceding system embodiment, wherein in the respective sample pickup configuration C_{P} the solvent pump is fluidly connected to the separation column.
S20. The system according to any of the 2 preceding system embodiments and with the features of S6, wherein the system is configured such that the solvent pump remains fluidly connected to the separation column when switching from the injection configuration C_{I} to the equilibration configuration C_{I} in any one of the three injection setups.
S21. The system according to any of the 3 preceding system embodiments, wherein in the respective sample pickup configuration C_{P} of the first injection setup S₁ and of the second injection setup S₂ the sample loop is comprised in the fluidic connection of the first device connection to the sample pickup means.
S22. The system according to any of the 4 preceding system embodiments, wherein in the respective sample pickup configuration C_{P} of the third injection setup S₃ the sample loop is not comprised in the fluidic connection of the first device connection to the sample pickup means.
S23. The system according to any of the preceding system embodiments, wherein the system is configured to assume a respective precompression configuration C_{C} in each of the three injection setups, wherein the first device connection and the second device connection are fluidly connected to a dead end and wherein one of said fluidic connections comprises the sample loop.
S24. The system according to the preceding system embodiment, wherein in the respective precompression configuration C_{C} the solvent pump is fluidly connected to the separation column.
S25. The system according to any of the 2 preceding system embodiments and with the features of S18, wherein the system is configured such that the solvent pump remains fluidly connected to the separation column when switching from the sample pickup configuration C_{P} to the equilibration configuration C_{E} in any one of the three injection setups.
S26. The system according to any of the preceding system embodiments, wherein the system is configured to assume a respective pickup wash configuration C_{WP} in each of the three injection setups, wherein the sample pickup means is fluidly detached from the seat while at least a tip of the sample pickup means remains within an inner volume of the seat, and wherein the at least one washing pump is fluidly connected to the seat.
S27. The system according to any of the preceding system embodiments, wherein the system is configured to assume a respective metering device compression configuration C_{MC} in the second injection setup S₂ or the third injection setup S₃, wherein both connections of the metering device are fluidly connected to a respective dead end, without the sample loop or the separation column being comprised by said fluidic connections.
S28. The system according to any of the preceding system embodiments, wherein the system is configured to assume a respective pump purge configuration C_{PP} in each of the three injection setups, wherein the solvent pump is fluidly connected to waste without the metering device, the sample loop, the sample pickup means, the seat or the separation column being part of said fluidic connection.
S29. The system according to any of the preceding system embodiments, wherein the system is configured to assume a respective metering device purge configuration C_{PM} in each of the three injection setups, wherein the metering device is fluidly connected to the solvent pump and to either one of the waste or the sample pick up means, allowing the solvent pump to purge the metering device.
S30. The system according to any of the preceding system embodiments, wherein the system is configured to assume a respective pump leak test configuration C_{LP} in each of the three injection setups, wherein the solvent pump is fluidly connected to a dead end without the separation column, the metering device, the sample loop, the sample pickup means or the seat being part of said fluidic connection.
S31. The system according to any of the preceding system embodiments, wherein the system is configured to assume a respective system leak test configuration C_{LS} in the first injection setup S₁ and in the third injection setup S₃, wherein the solvent pump is fluidly connected to a dead end and wherein said fluidic connection comprises the metering device, the sample pickup means and the seat, but not the separation column.
S32. The system according to any of the preceding system embodiments, wherein the system is configured to assume a respective pickup means leak test configuration C_{LSP} in the first injection setup S₁ and in the second injection setup S₂, wherein the solvent pump is fluidly connected to a dead end and wherein said fluidic connection comprises the sample pickup means, and the seat, but not the metering device, or the separation column.
S33. The system according to any of the preceding system embodiments, wherein the system is configured to assume a respective metering device leak test configuration C_{LM} in the first injection setup S₁ and in the second injection setup S₂, wherein the solvent pump is fluidly connected to a dead end and wherein said fluidic connection comprises the metering device, but not the sample pickup means, the seat, or the separation column.
S34. The system according to any of the preceding system embodiments, wherein the system further comprises a check valve fluidly connected to the at least one washing pump and configured to prevent flow from other parts of the system towards the at least one washing pump.
That is, the check valve may protect the at least one washing pump from system pressures, which may be too high for the at least one washing pump.
S35. The system according to any of the preceding system embodiments, wherein the injection valve comprises at least four connecting elements.
S36. The system according to the preceding system embodiment, wherein the injection valve comprises exactly four connecting elements.
S36. The system according to any of the preceding system embodiments, wherein the injection valve is a shear valve comprising a rotor and a stator.
S37. The system according to the preceding system embodiment, wherein the at least 8 ports are comprised by the stator.
S38. The system according to the preceding system embodiment, wherein a first port is located at a centre of the stator, while the remaining 7 ports are located equally spaced in a circumferential direction on a circle around the first port.
S39. The system according to the preceding system embodiment and with the features of S35, wherein a first connecting element is generally hook-shaped and dimensioned such that it can fluidly connect the first port to each of the other ports, respectively.
S40. The System According to any of the 2 Preceding System Embodiments, Wherein the second and third connecting element comprise the shape of an arc oriented along the circle and dimensioned such that they can connect two neighbouring ports on the circle without any dead volume in said connection.
S41. The system according to any of the 3 preceding system embodiments, wherein the fourth connecting element comprises a shape that allows to connect two neighbouring outer ports on the circle both with or without dead volume.
S42. The system according to any of the 6 preceding system embodiments and with the features of S35, wherein the at least four connecting elements are provided through grooves in the stator and/or rotor, preferably only in the rotor.
S43. The system according to any of the preceding system embodiments, wherein an outlet of the separation column is fluidly connected to a detector, preferably a detector comprised by the system.
S44. The system according to the preceding system embodiment, wherein the detector is one of a charged aerosol detector (CAD), a mass spectrometer, a fluorescence detector, a refractive-index detector, an absorbance detector, or an evaporative-light-scattering detector.
S45. The system according to any of the preceding system embodiments, wherein in the first injection setup S₁
the solvent pump is directly fluidly connected to a first port;
the separation column is directly fluidly connected to a second port;
the first device connection of the metering device is directly fluidly connected to an eighth port;
   the second device connection of the metering device is directly fluidly connected to a sixth port;
a first end of the sample loop is directly fluidly connected to a seventh port;
a second end of the sample loop is directly fluidly connected to the sample pickup means;
the seat is directly fluidly connected to a third port;
the at least one washing pump is directly fluidly connected to a fourth port; and
the waste is directly fluidly connected to a fifth port.
   S46. The system according to any of the preceding system embodiments, wherein in the second injection setup S₂
the solvent pump is directly fluidly connected to a first port;
the separation column is directly fluidly connected to a second port;
the first device connection of the metering device is directly fluidly connected to a seventh port;
   the second device connection of the metering device is directly fluidly connected to a fifth port;
a first end of the sample loop is directly fluidly connected to an eight port;
a second end of the sample loop is directly fluidly connected to the sample pickup means;
the seat is directly fluidly connected to a third port;
the at least one washing pump is directly fluidly connected to a fourth port; and
the waste is directly fluidly connected to a sixth port
   S47. The system according to any of the preceding system embodiments, wherein in the third injection setup S₃
the solvent pump is directly fluidly connected to a first port;
the separation column is directly fluidly connected to a fifth port;
the first device connection of the metering device is directly fluidly connected the sample pickup means;
   the second device connection of the metering device is directly fluidly connected to an eighth port;
a first end of the sample loop is directly fluidly connected to a fourth port;
a second end of the sample loop is directly fluidly connected to a sixth port;
the seat is directly fluidly connected to a third port;
the at least one washing pump is directly fluidly connected to a second port; and
the waste is directly fluidly connected to a seventh port
   S48. The system according to any of the preceding system embodiments, wherein the system comprises a controller configured to control the system.
   S49. The system according to the preceding system embodiment, wherein the controller is configured to operate the chromatography system according to any of the preceding method embodiments.
   S50. The system according to any of the preceding system embodiments, wherein the injection valve is a valve according to any of the preceding valve embodiments.
   M59. The method according to any of the preceding method embodiments, wherein the chromatography system is a chromatography system according to any of the preceding system embodiments.

Below, reference will be made to computer program product embodiments. These embodiments are abbreviated by the letter “C” followed by a number. Whenever reference is herein made to “program embodiments”, these embodiments are meant.

C1. Computer program product comprising instructions which, when the program is executed by the controller of a chromatography system according to system embodiment S48, cause the controller to operate the chromatography system according to any of the preceding method embodiments.

Embodiments of the present invention will now be described with reference to the accompanying drawings. These embodiments should only exemplify, but not limit, the present invention.

FIG. 1 depicts an exemplary system in the first injection setup and assuming the injection configuration;

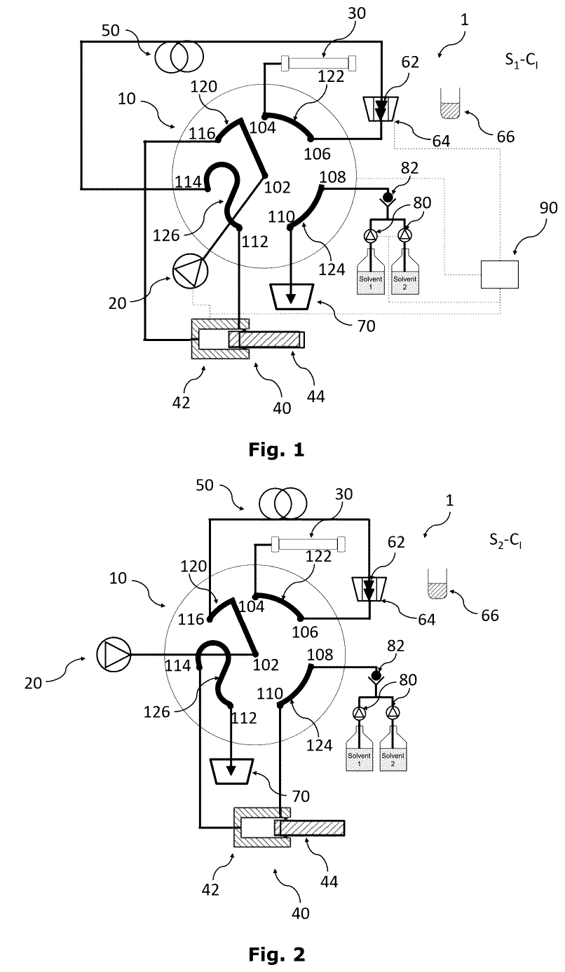

FIG. 2 depicts the exemplary system in the second injection setup and assuming the injection configuration;

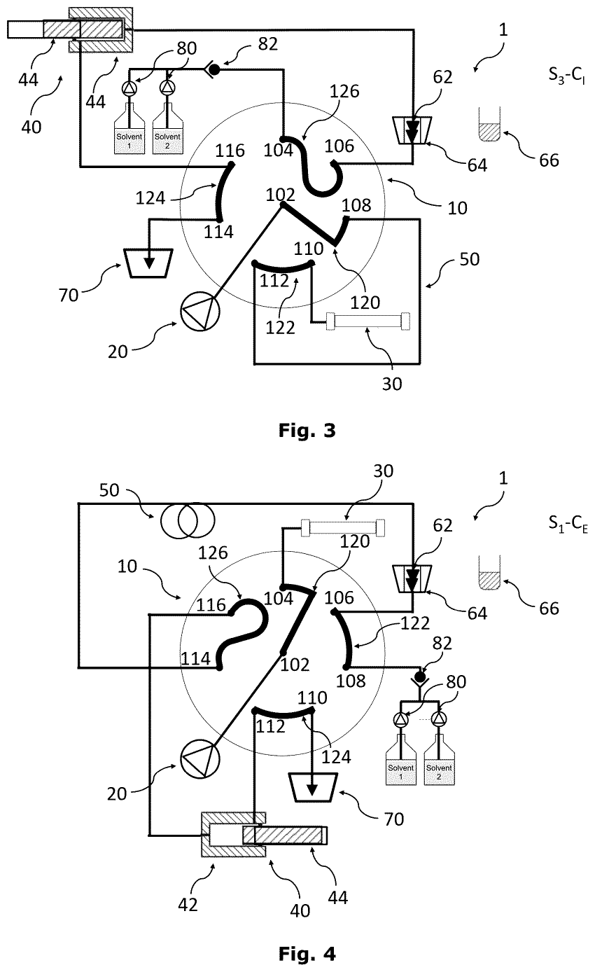

FIG. 3 depicts the exemplary system in the third injection setup and assuming the injection configuration;

FIG. 4 depicts the exemplary system in the first injection setup and assuming the equilibration configuration;

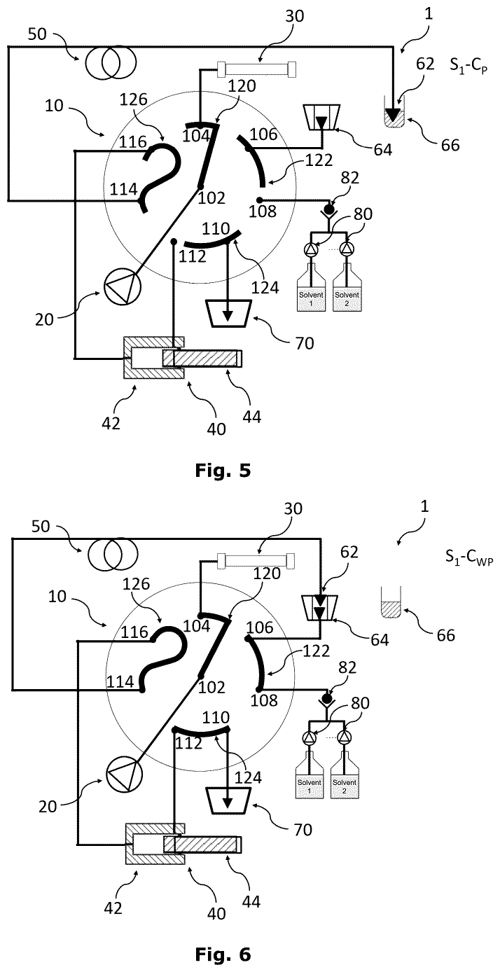

FIG. 5 depicts the exemplary system in the first injection setup and assuming the sample pickup configuration;

FIG. 6 depicts the exemplary system in the first injection setup and assuming the pickup wash configuration;

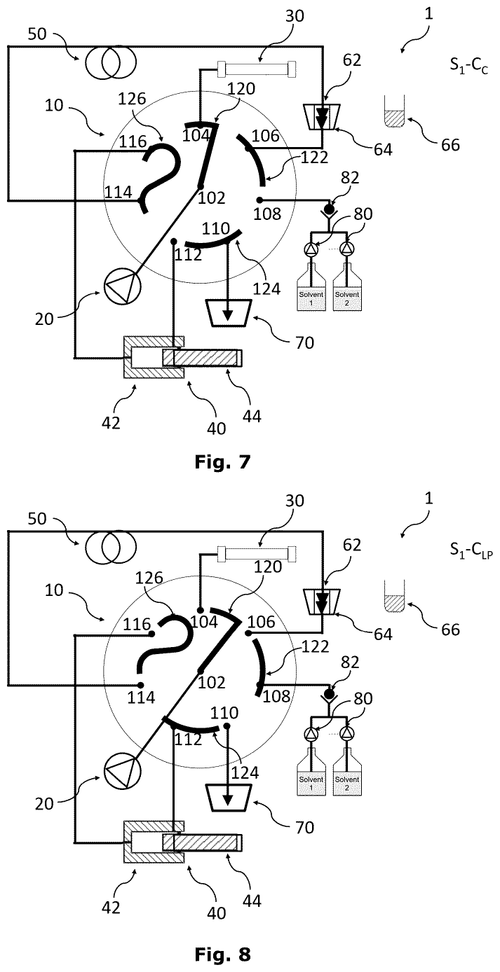

FIG. 7 depicts the exemplary system in the first injection setup and assuming the sample precompression configuration;

FIG. 8 depicts the exemplary system in the first injection setup and assuming the pump leak test configuration;

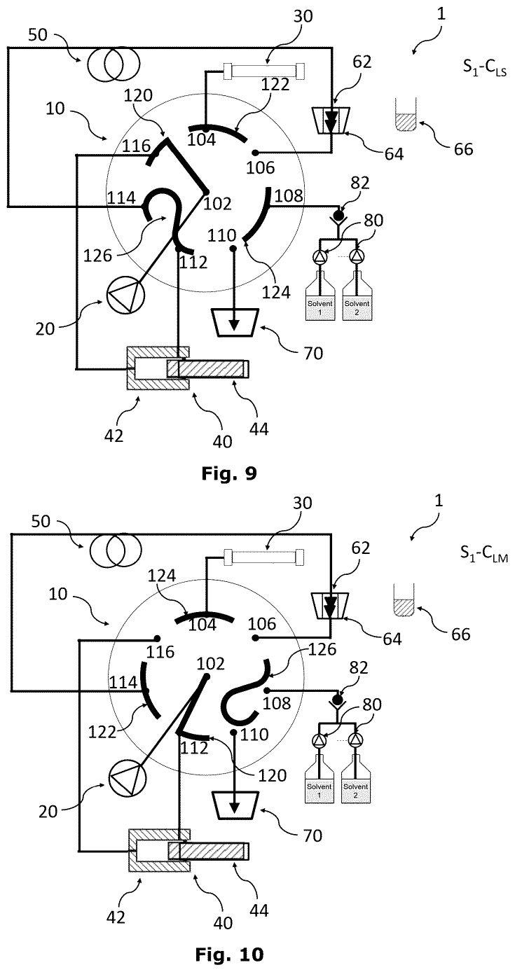

FIG. 9 depicts the exemplary system in the first injection setup and assuming the system leak test configuration;

FIG. 10 depicts the exemplary system in the first injection setup and assuming the metering device leak test configuration;

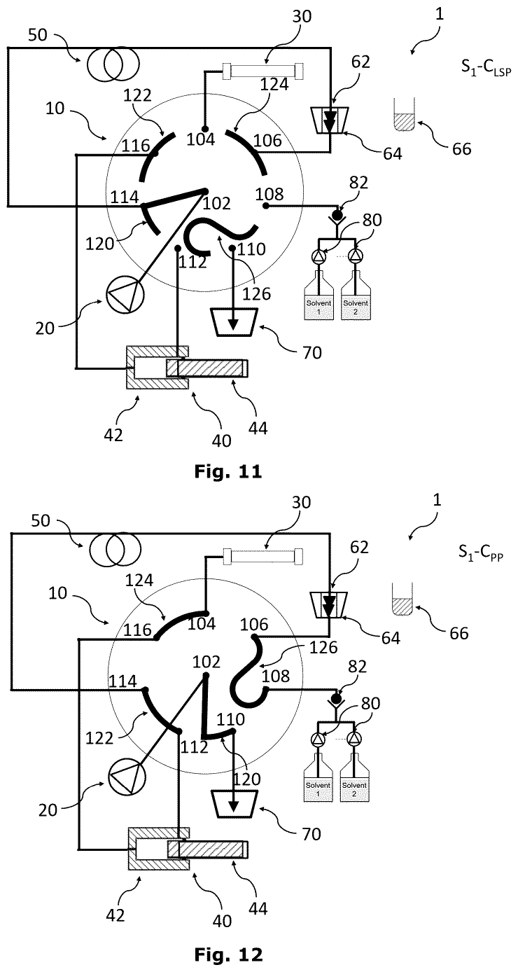

FIG. 11 depicts the exemplary system in the first injection setup and assuming the pickup means leak test configuration;

FIG. 12 depicts the exemplary system in the first injection setup and assuming the pump purge configuration;

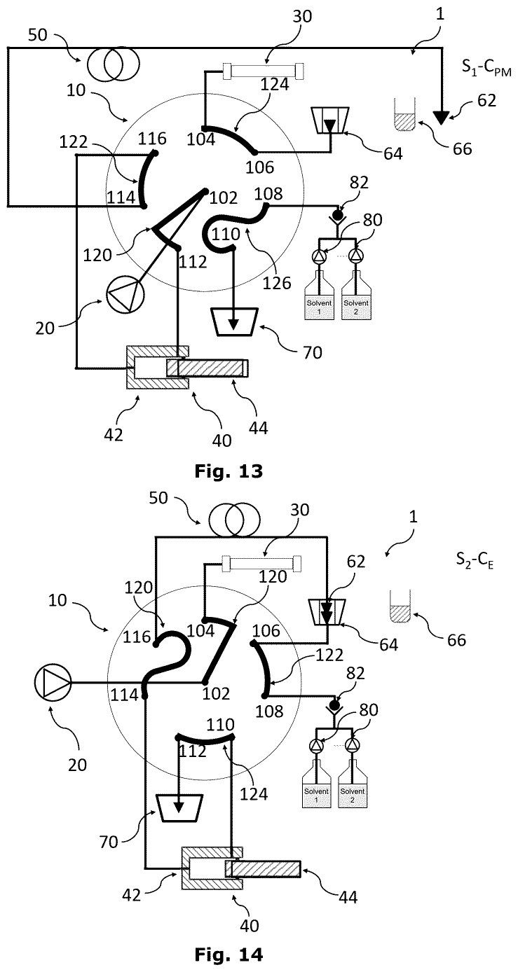

FIG. 13 depicts the exemplary system in the first injection setup and assuming the metering device purge configuration;

FIG. 14 depicts the exemplary system in the second injection setup and assuming the equilibration configuration;

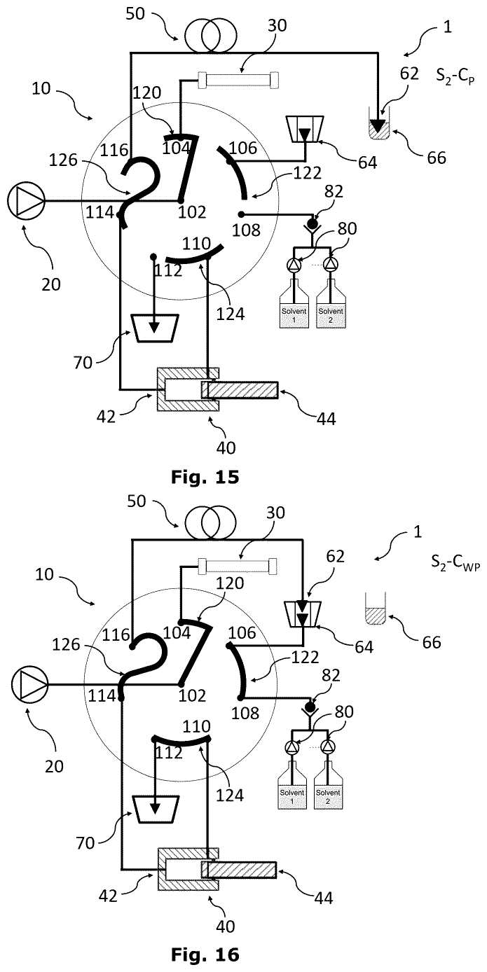

FIG. 15 depicts the exemplary system in the second injection setup and assuming the sample pickup configuration;

FIG. 16 depicts the exemplary system in the second injection setup and assuming the pickup wash configuration;

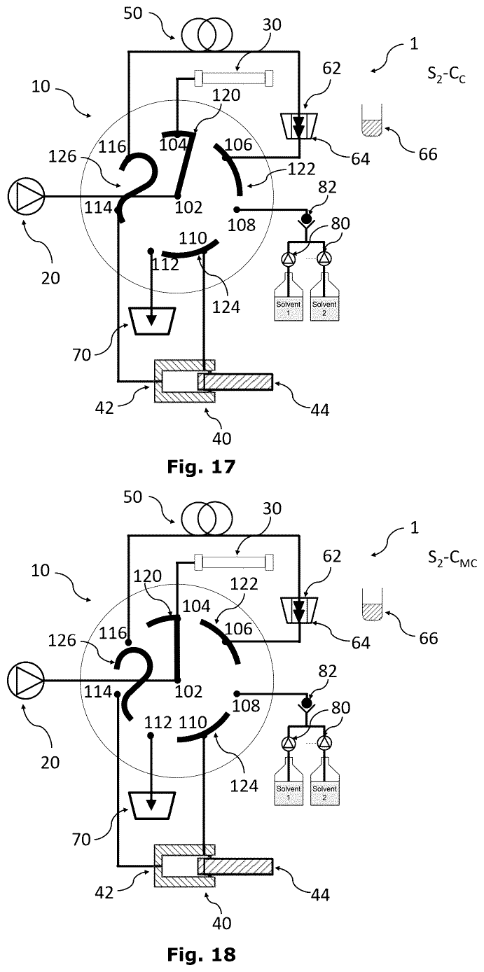

FIG. 17 depicts the exemplary system in the second injection setup and assuming the sample precompression configuration;

FIG. 18 depicts the exemplary system in the second injection setup and assuming the metering device compression configuration;

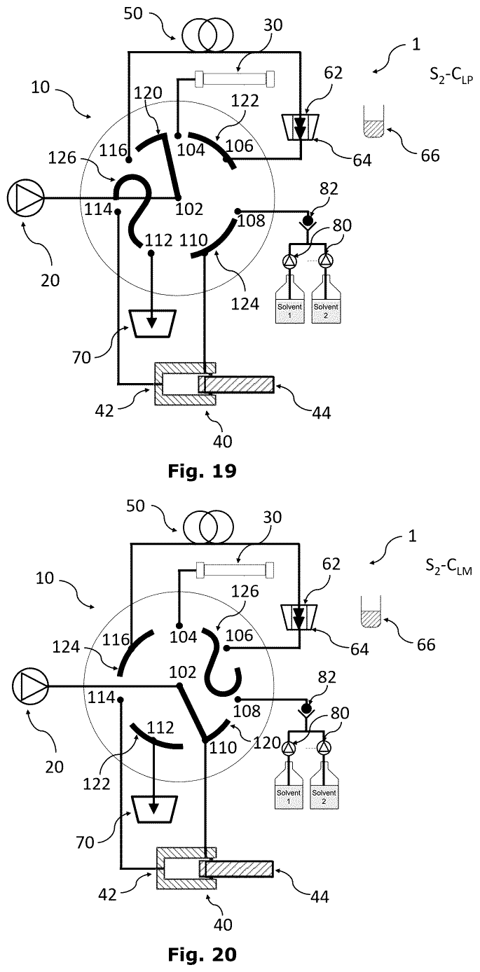

FIG. 19 depicts the exemplary system in the second injection setup and assuming the pump leak test configuration;

FIG. 20 depicts the exemplary system in the second injection setup and assuming the metering device leak test configuration;

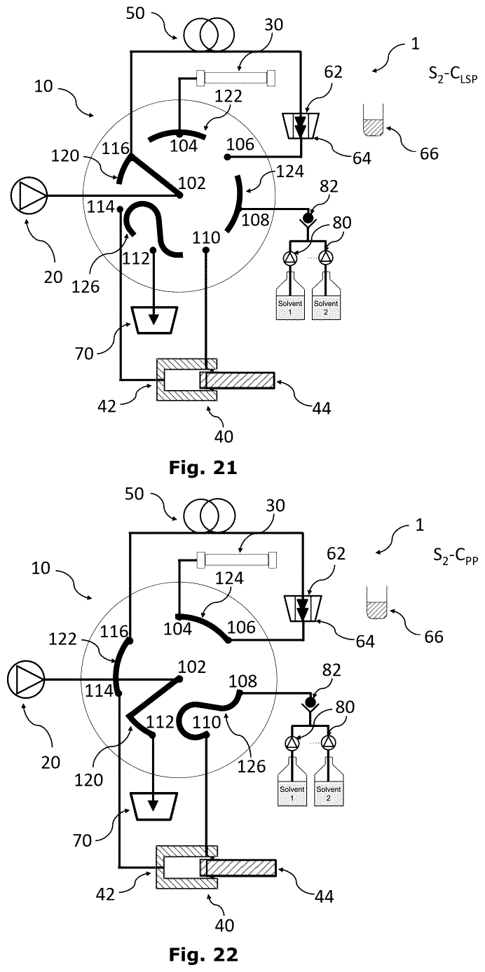

FIG. 21 depicts the exemplary system in the second injection setup and assuming the pickup means leak test configuration;

FIG. 22 depicts the exemplary system in the second injection setup and assuming the pump purge configuration;

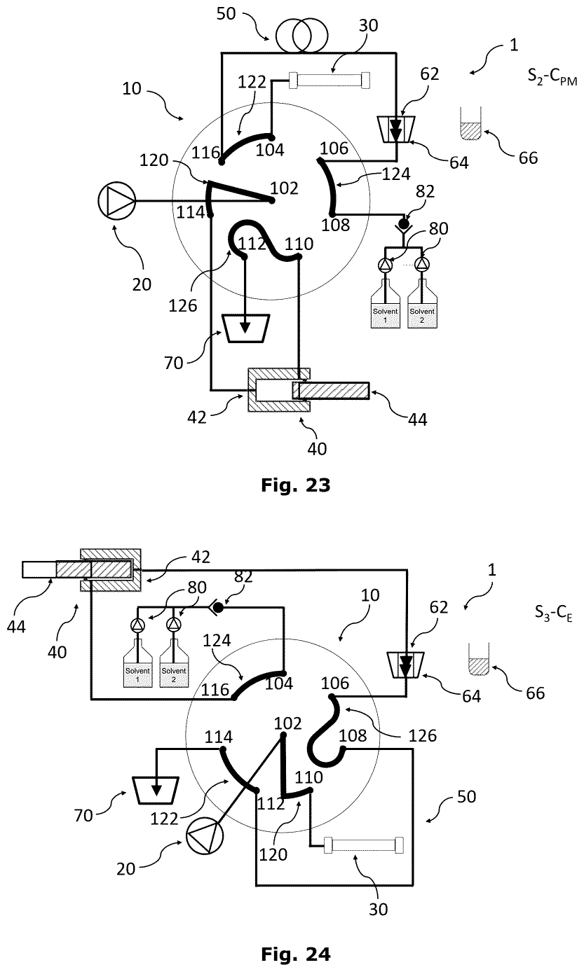

FIG. 23 depicts the exemplary system in the second injection setup and assuming the metering device purge configuration;

FIG. 24 depicts the exemplary system in the third injection setup and assuming the equilibration configuration;

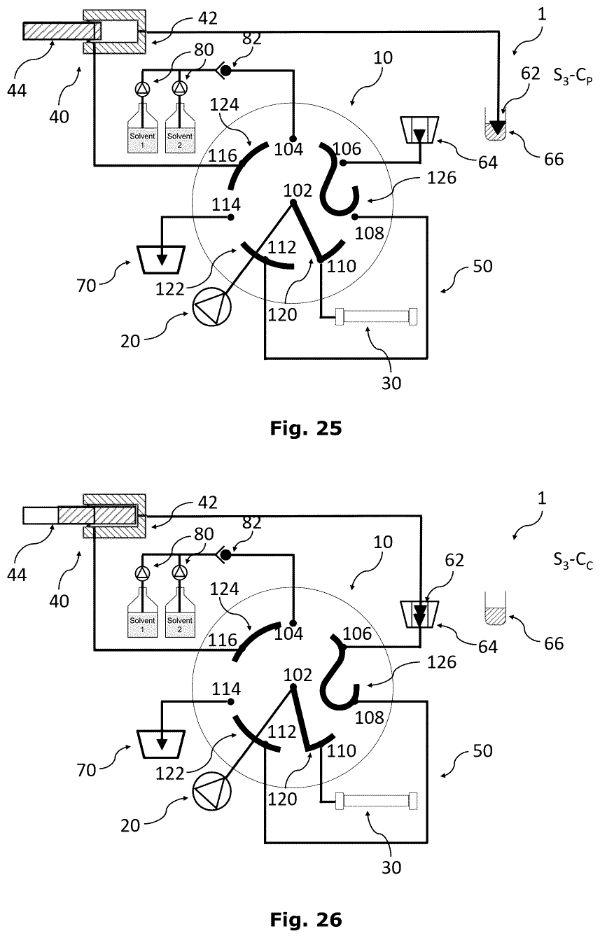

FIG. 25 depicts the exemplary system in the third injection setup and assuming the sample pickup configuration;

FIG. 26 depicts the exemplary system in the third injection setup and assuming the sample precompression configuration;

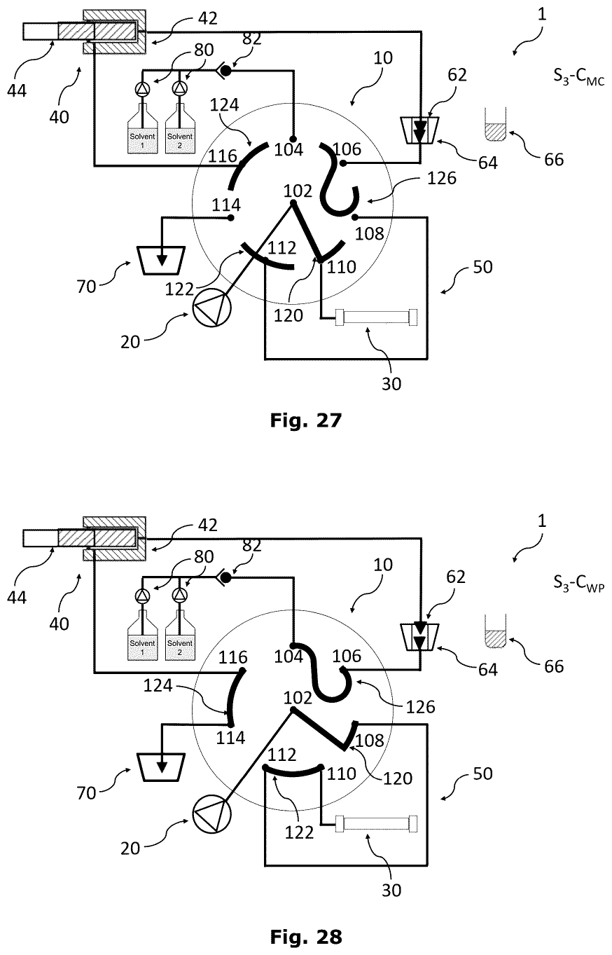

FIG. 27 depicts the exemplary system in the third injection setup and assuming the metering device compression configuration;

FIG. 28 depicts the exemplary system in the third injection setup and assuming the pickup wash configuration;

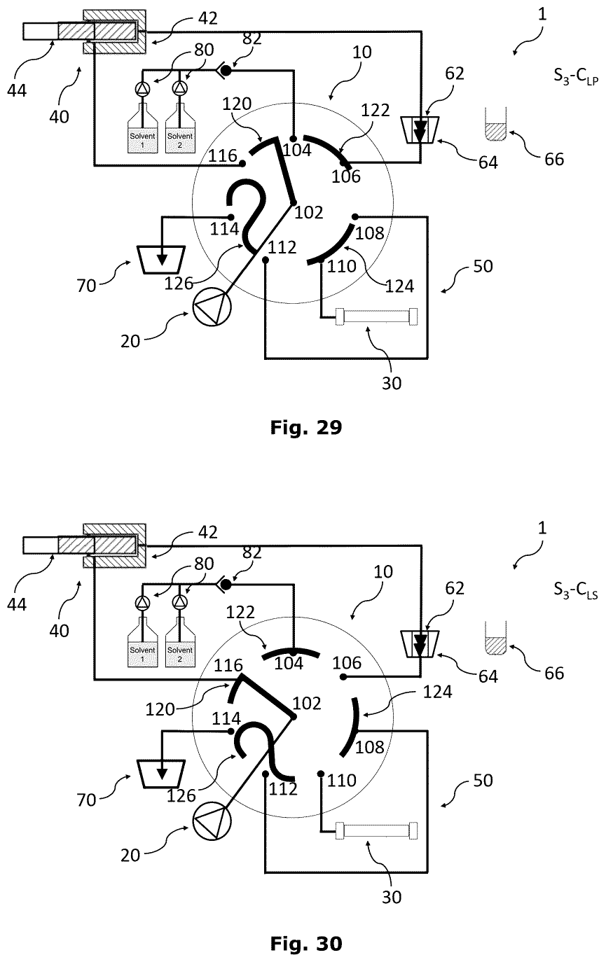

FIG. 29 depicts the exemplary system in the third injection setup and assuming the pump leak test configuration;

FIG. 30 depicts the exemplary system in the third injection setup and assuming the system leak test configuration;

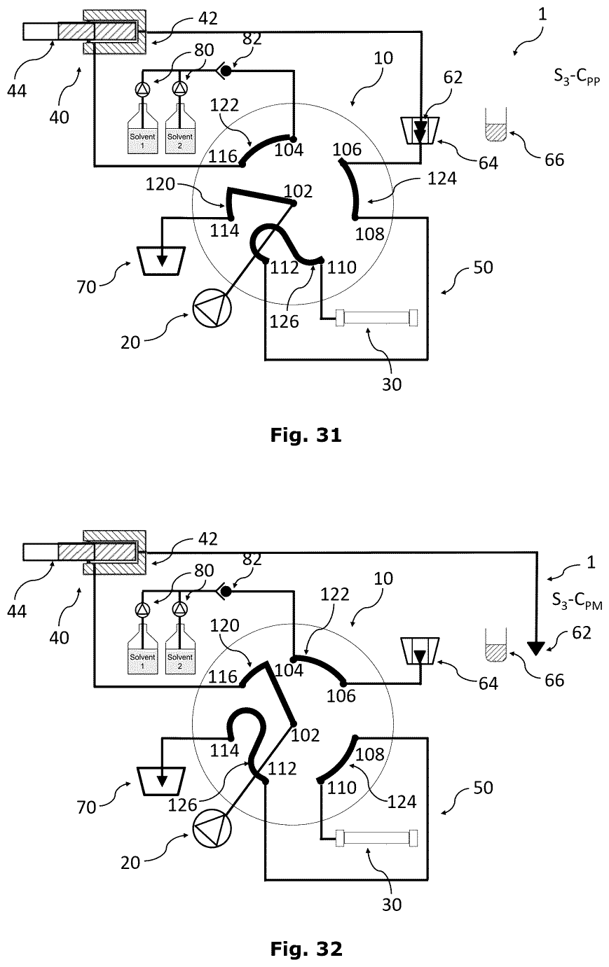

FIG. 31 depicts the exemplary system in the third injection setup and assuming the pump purge configuration;

FIG. 32 depicts the exemplary system in the third injection setup and assuming the metering device purge configuration;

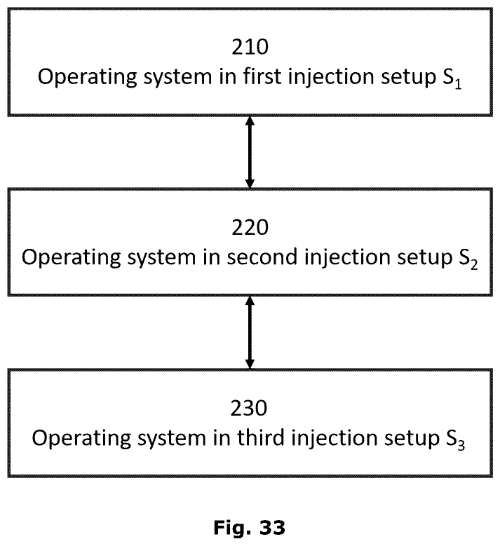

FIG. 33 depicts an exemplary embodiment of a method according to the present invention; and

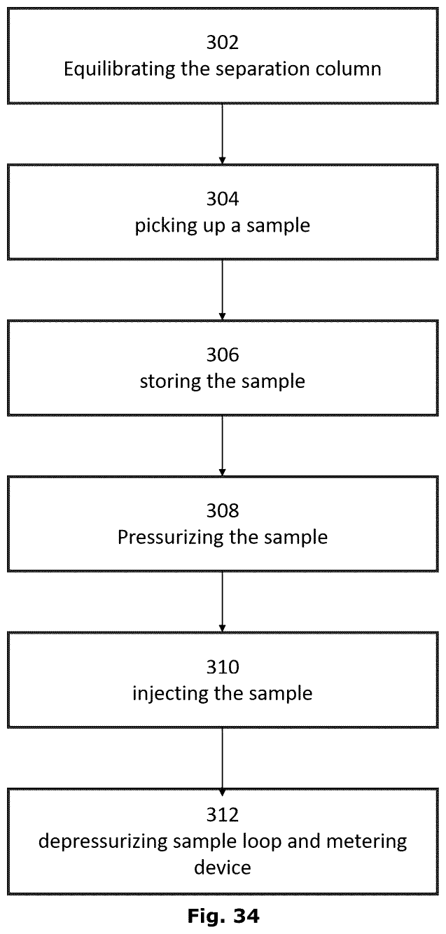

FIG. 34 depicts method steps of operating the system in an injection setup.

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

In one embodiment, the present invention relates to a chromatography system 1 comprising a distribution valve 10, a solvent pump 20, a separation column 30, a metering device 40, a sample loop 50, a sample pickup means 62, e.g. a needle 62, a seat 64 configured to receive the sample pickup means 62, e.g. a needle seat 64, a waste 70 and at least one washing pump 80. It will be understood that the chromatography system may further comprise a plurality of tubes (e.g. capillary tubes) to establish fluidic connections between different components of the system. The solvent pump 20 may also simply be referred to as the pump 20.

The distribution valve 10 may also be referred to as injection valve 10 since it is directly involved in the injection, particularly it enables establishing the fluidic connections required for injecting a sample.

With reference to FIG. 1, the at least one washing pump 80 may optionally be secured with a check valve 82, particularly if a back pressure of the system could damage the at least one washing pump 80, e.g. if the at least one washing pump is designed as a diaphragm pump. Generally, there may be one or more washing pumps 80 which may each access one or more solvents, e.g. via a proportioning valve.

The injection valve 10 may be a shear valve, particularly it may comprise a stator, a rotor and a rotatable drive. The stator may comprise at least 8 ports 102, 104, 106, 108, 110, 112, 114, 116. Furthermore, stator and rotor may comprise connecting elements 120, 122, 124, 126 (e.g. grooves) to connect the ports to one another. Preferably, these connecting elements may solely be located in the rotor. Thus, advantageously no connecting elements (e.g., grooves) may be located in the stator. The rotor can be rotated with respect to the stator (by means of the rotatable drive) so that the connecting elements may establish connections between different ports. The rotatable drive can include a motor, gearbox, and encoder.

The metering device 40 may comprise a housing 42 and a piston 44. The metering device 40 may also be referred to as sampling device 40. The metering device may also comprise a stepper motor or a drive device for moving the piston 44 in the housing 42. The metering device 40 may for example be a motorized syringe.

Furthermore, the system 1 may also comprise a controller 90 as depicted in FIG. 1. For sake of simplicity and readability the controller 90 may be omitted in the following Figures. The controller 90 can be operatively connected to other components, as depicted by dashed lines in FIG. 1. More particularly, the controller 90 may be operatively connected to the injection valve 10 (and more particularly to the rotatable drive thereof), to the sample pickup means 62, to the solvent pump 20, the metering device 40 (more particularly, to the stepper motor or drive device of the metering device 40) and/or the at least one washing pump 80. The connection between the controller 90 and other system components may be wired and/or wireless. Furthermore, the controller being operatively connected may comprise the controller being able to transmit and/or receive digital signals, analog signals and/or data to/from operatively connected components, said data may for example comprises sensor data, operating instructions, etc.

The controller 90 can include a data processing unit and may be configured to control the system 1 and carry out particular method steps. The controller can send or receive electronic signals for instructions. The controller can also be referred to as a microprocessor. The controller can be contained on an integrated-circuit chip. The controller can include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

Furthermore, it should be understood that the system 1 may be configured to measure pressures at different locations of the system. For example, the system may comprise a plurality of pressure sensors. For example, a first pressure sensor may be located in or at the solvent pump 20 and a second pressure sensor may be located in the metering device 40. These pressure sensors may also be operatively connected to the controller 90, and the controller 90 may use readings of these pressure sensors when controlling the operation of the system 1. The pressure sensors may be configured to measure the pressure directly. However, it should be understood that also other parameters may be measured and may be used to determine the respective pressures (and that such a procedure should also be understood as a pressure measurement and the components involved should be understood as pressure sensors). For example, it will be understood that when a pump 20, 80 supplies a fluid at a flow rate, the power consumption of the pump 20, 80 will also depend on the pressure at which it operates—the higher the operating pressure, the higher the power consumption. Thus, e.g., the power consumption of the pump 20, 80 may also be used to derive the pressure present at the pump 20, 80. A corresponding consideration also applies for the metering device 40: The higher the pressure present in the metering device 40, the higher the power consumption when the piston 44 is moved further into the housing 42. Thus, the system 1 may generally be configured to measure pressures present at different locations of the system 1.

The system may generally be configured to be operated in three different injection setups S₁, S₂, S₃. With reference to FIG. 1, a first injection setup S₁ may allow for a split-loop injection with the metering device 40 being present in an analytical path. The analytical path may generally denote a flow path between the solvent pump 20 and the separation column 30 during sample injection. In other words, the metering device 40, the sample loop 50, the sample pickup means 62 and the seat 64 may be comprised by the analytical path during sample injection when operating the system 1 in the first injection setup S₁. It will be understood that also a selection of ports and connecting elements of the injection valve 10 as well as respective tubing will be comprised by the analytical path. Thus, the first injection setup S₁ may generally allow for an adjustment of the GDV by means of the metering device 40. This may for example be advantageous for emulating an HPLC method previously run on an older HPLC system with a larger GDV. Furthermore, the metering device 40 may advantageously be continuously flushed/washed during analysis.

It will be understood that the system 1 may be operated in at least three different injection setups. Within each injection setup, the system may assume a plurality of different configurations, relating to an actual valve position as well as for example a position of the sample pickup means 62 with respect to the seat 64.

The system being configured to assume a certain configuration requires the system to be configured to actually assume the configuration for a finite amount of time and particularly a corresponding valve position for performing a certain task. A system which is merely suitable to generally assume a respective configuration without there being any technical measures to actually assume said configuration is not considered to be configured to assume said configuration. In particular, a valve that simply moves through a valve position that would be required to be assumed when assuming a respective configuration does not assume said position and thus the system does not assume said configuration and is also not configured to assume said configuration.

FIG. 1 depicts an exemplary embodiment of a chromatography system 1 in the first injection setup S₁ and assuming an injection configuration C_{I}. In other words, FIG. 1 depicts an injection configuration C_{I} of a system operated in the first injection setup S₁. In general, the injection configuration C_{I} denotes a configuration wherein a sample may be injected, i.e. provided to the separation column 30. Consequently, in the injection configuration C_{I} an output of the solvent pump 20 may be fluidly connected to an inlet of the separation column 30, wherein a resulting flow path between the solvent pump 20 and the separation column 30 is denoted as analytical path. In the first injection setup S₁ the analytical path comprises the metering device 40, the sample loop 50, the sample pickup means 62, and the seat 64, as well as connecting elements and ports of the valve and tubing.

In the depicted exemplary embodiment, the solvent pump 20 may be directly fluidly connected to a first port 102 of the injection valve 10. In the context of this application being “directly fluidly connected to” another component means that no other port (or connection element) of the injection valve 10 is part of said connection. An inlet of the solvent pump 20 may be fluidly connected to at least one solvent reservoir (not shown). The solvent pump 20 may for example be a binary pump or a quaternary pump fluidly connected to a plurality of solvent reservoirs and configured to provide a desired solvent composition.

Similarly, the separation column 30 may be directly fluidly connected to a second port 104. In particular, the inlet of the separation column 30 may be directly fluidly connected to the second port 104. An outlet of the separation column may be fluidly (preferably directly fluidly) connected to a detector. The detector may be comprised by the system and may be configured to analyse an effluent of the separation column 30. A detector may for example be one of a CAD, a mass spectrometer, a fluorescence detector, a refractive-index detector, an absorbance detector, or an evaporative-light-scattering detector.

The metering device 40 may be directly fluidly connected to a sixth and eighth port 112, 116. That is, a first device connection of the metering device 40 may be directly fluidly connected to the eighth port 116 and a second device connection of the metering device 40 may be directly fluidly connected to the sixth port 112.

The sample loop 50 may be directly fluidly connected to a seventh port 114 at a first end and a second end of the sample loop 50 may be directly fluidly connected to the sample pickup means 62 (i.e. without a port being within said fluidic connection). The seat 64 for receiving the sample pickup means 62 may be directly fluidly connected to a third port 106. The sample pickup means 62 may be configured to be moved between the seat 64 and at least one sample vial 66. Thus, the system 1 may comprise a split-loop configuration, wherein a sample may be loaded into the sample loop 50 by separating the sample pickup means 62 from the seat 64 and moving it so a respective sample vial 66.

Additionally, the exemplary system comprises a waste 70 directly fluidly connected to a fifth port 110.

Furthermore, the exemplary system comprises 2 washing pumps 80, each comprising and inlet fluidly connected to a respective solvent reservoir. Generally, the system may comprise at least one washing pump 80. The washing pumps 80 are directly fluidly connected to a fourth port 108 of the injection valve 10, wherein the outlets of the two washing pumps 80 are combined. The fluidic connection to the injection valve may comprise a check valve 82 to protect the at least one washing pump 80 from undesired high pressures. Generally, an inlet of each of the at least one washing pump 80 may be fluidly connected to at least one solvent reservoir. Particularly, an inlet of at least one washing pump 80 may be fluidly connected to a plurality of solvent reservoirs, e.g. via a proportional valve. This may advantageously allow to use only a single washing pump 80, while being able to provide a mixture of solvents.

The injection valve 10 may comprise a first connecting element 120, a second connecting element 122, a third connecting element 124 and a fourth connecting element 126. These connecting elements may preferably be grooves. Preferably, these connecting elements are located in the rotor of the injection valve 10. Thus, the connecting elements may be grooves in the rotor of the injection valve 10. The ports may preferably be located in the stator of the injection valve. Thus, the injection valve 10 may assume different valve positions by changing the relative position of the stator and the rotor, whereby different ports are connected by different connecting elements. In some valve positions at least some of the ports may also be blocked, i.e. not connected to another port via a connecting element.

The first port 102 may be located in a centre of the stator, while the remaining 7 ports may be located on a circle around the first port 102. Thus, the 7 outer ports may preferably be equally distanced from the central first port 102. Preferably, the outer 7 ports may be equally spaced in a circumferential direction. Such an equally spaced, circumferential distribution around the central port advantageously facilitates easy access to all ports and furthermore enables to provide outer ports wherein the respective bores are all at the same angle, which reduces complexity.

The connecting elements 120, 122, 124, 126 may comprise different shapes. The first connecting element 120, may be generally hook-shaped and dimensioned such that it can fluidly connect the first port 102, to any of the other ports. A longer portion of the hook-shaped first connecting element 120 may be running from the centre of the rotor outwards to the circle in which the remaining, outer ports lie. A shorter portion of the first connecting element 120 may lie on said circle.

It will be appreciated that the first connecting element 120 may connect the first port 102 to other ports free of dead volume or with a dead volume. For example, in the configuration depicted in FIG. 1, the first port 102 is connected to the eighth port 116 free of dead volume. That is, there is no dead volume caused by the connection between the first port 102 and the eighth port 116. As a further example, reference is made of FIG. 5. In this Figures, there is a connection between the first port 102 and the second port 104. However, this connection is not free of dead volume. Instead, this connection causes a dead volume being formed in the first connection element 120. More particularly, the connecting element 120 extends beyond the point where it is connected to the second port 104, thus creating a dead volume.

The second 122 and third 124 connecting element may also be in the shape of an arc oriented along the circle and dimensioned to fluidly connect two neighbouring ports on the circle. Preferably the second 122 and third 124 connecting element are dimensioned such that they can connect two neighbouring, outer ports without any dead volume in said connection. That is, the length may be chosen such that it is just sufficient for connecting two neighbouring ports.

The fourth connecting element 126 may resemble a shape that allows to connect two neighbouring outer ports on the circle either with or without dead volume. This may for example be enabled by resembling a sickle-shape or question-mark-shape as depicted in FIG. 1.

With reference to FIG. 2 an exemplary embodiment of a chromatography system 1 in the second injection setup S₂ and assuming the injection configuration C_{I} is discussed. In other words, FIG. 2 depicts an injection configuration C_{I} of a system operated in the second injection setup S₂. In the second injection setup S₂ the analytical path comprises the sample loop 50, the sample pickup means 62, and the seat 64, as well as connecting elements and ports of the valve and tubing when assuming the injection configuration C_{I}. In particular, the analytical path does not comprise the metering device 40 in contrast to the injection configuration in the first injection setup S₁-C_{I}.

Thus, the second injection setup S₂ may generally allow for a reduced (e.g. optimized) GDV since the volume of the metering device 40 does not contribute to the GDV. This may for example be advantageous for analyses with low flows, since an increased GDV would cause a long analysis time as the gradient has to be pumped through the entire volume. In other words, it may allow for a comparatively high sample throughput.

In the second injection setup S₂ and for the discussed exemplary embodiment the solvent pump 20 may also be directly fluidly connected to the first port 102 of the injection valve 10. Similarly, the separation column 30 may be directly fluidly connected to the second port 104. In particular, the inlet of the separation column 30 may be directly fluidly connected to the second port 104. In other words, the fluidic connections of the solvent pump 20 and the separation column 30 to the injection valve 10 may be the same as in the first injection setup S₁.

Similarly, also the seat 64 is directly fluidly connected to the third port 106 and the at least one washing pump 80 is directly fluidly connected to the fourth port 108, as in the first injection setup S₁.

The metering device 40 may be directly fluidly connected to a fifth and seventh port 110, 114. That is, the first device connection of the metering device 40 may be directly fluidly connected to the seventh port 114 and the second device connection of the metering device 40 may be directly fluidly connected to the fifth port 110. The waste 70 may be directly fluidly connect to the sixth port 106 and the first end of the sample loop 50 may be fluidly connected to the eighth port 116.

Thus, switching the system 1 from the first injection setup S₁ to the second injection setup S₂ (or vice versa) requires interchanging the fluidic connections of some system components to ports of the injection valve 10. This may typically be performed manually by a user, who may be instructed by the system. However, changing from the first injection setup S₁ to the second injection setup S₂ advantageously merely requires swapping a few fluidic connections to the valve, which may for example easily be achieved by unscrewing some of the fluidic connections at the injection valve 10, rearranging said unscrewed connections.

With reference to FIG. 3 an exemplary embodiment of a chromatography system 1 in the third injection setup S₃ and assuming the injection configuration C_{I} is discussed. In other words, FIG. 3 depicts an injection configuration C_{I} of a system operated in the third injection setup S₃. In the third injection setup S₃ the analytical path comprises the sample loop 50 as well as connecting elements and ports of the valve and tubing when assuming the injection configuration C_{I}. In particular, the analytical path does not comprise the metering device 40, the sample pickup means 62 and the seat 64 in contrast to the injection configuration in the first injection setup S₁-C_{I} and in the second injection setup S₂-C_{I}.

Thus, the third injection setup S₃ allows for a pushed loop injection, particularly a partial-loop injection and/or full-loop injection. The third injection setup S₃ may thus advantageously allow for injecting a precise sample volume with high repetition accuracy when performing a full-loop injection. Compared to the first injection setup S₁ and the second injection setup S₂ the GDV may be further optimized (reduced). Additionally, the components in the analytical path are minimized and thus potential sources of leaks and/or contamination are reduced. In particular, the additional absence of needle and needle seat may remove another source of error for leaks, carry over and dispersion. However, the third injection setup S₃ may require excess sample to ensure that the sample loop is only filled with sample and not with solvent from the metering device (if desired, e.g. for a full loop injection). In other words, the third injection setup may allow a precise insertion of a sample when performing a full-loop injection, as the entire sample loop is filled with sample. Nevertheless, partial filling of the sample loop may also be possible (partial-loop insertion). Both, full-loop injection and partial-loop injection may be realized as pushed-loop injection. This may be preferred to a pulled-loop injection, which can disadvantageously take a very long time in order to avoid creating negative pressure which may result in outgassing of solvent or sample.

In the third injection setup S₃ and for the discussed exemplary embodiment the solvent pump 20 may still be fluidly connected to the first port 102 of the injection valve 10. Similarly, also the seat 64 may be directly fluidly connected to the third port 106. Thus, the solvent pump 20 and the seat 63 may stay fluidly connected to the respective ports independent of the injection setup in which the system is operated.

The separation column 30 may be directly fluidly connected to the fifth port 110 of the injection valve. In particular, the inlet of the separation column 30 may be directly fluidly connected to the fifth port 110. The metering device 40 may be directly fluidly connected to the eighth port 116 and the sample pickup means 62. That is the first device connection of the metering device 40 may be directly fluidly connected to the sample pickup means 62 and the second device connection of the metering device 40 may be directly fluidly connected to the eighth port 116 of the injection valve 10. The sample pickup means 62 may be fluidly connected to the seat 64.

The at least one washing pump 80 may be directly fluidly connected to the second port 104. The waste 70 may be directly fluidly connected to the seventh port 114.

The sample loop 50 may be directly fluidly connected to the fourth port 108 and sixth port 112. Thus, the sample loop may not be directly fluidly connected to the metering device 40 and/or the sample pickup means 62, which allows for the system to assume the injection configuration S₃-C_{I}, wherein only the sample loop 50 is comprised by the analytical path and not the metering device 40, the sample pickup means 62 or the seat 64.

Thus, switching the system 1 from the first injection setup S₁ or the second injection setup S₂ to the third injection setup S₃ (or vice versa) requires interchanging the fluidic connections of some system components to ports of the injection valve 10, as well as fluidly connecting the sample pickup means 62 to the metering device 40 instead of the sample loop 50. Again, this may typically be manually performed by a user, who may be instructed by the system. However, changing from one of the three injection setups to another one advantageously merely requires swapping a few fluidic connections (mainly to the injection valve 10), which may for example easily be achieved by unscrewing some of the fluidic connections, rearranging said unscrewed connections. The user may optionally change the sample loop, which may typically be a capillary, to provide a desired volume, e.g. for full-loop injection.

Thus, the present system 1 advantageously allows for operation in three different injection setups S₁, S₂, S₃, wherein changing between injections setups does not require any change of hardware, e.g. changing the rotor or the total injection valve, but merely requires swapping some of the fluidic connections to the injection valve 10. This allows for great flexibility when using such a system since it can be adjusted to the current needs. It will be understood, the sample loop may be exchanged to provide a desired volume, e.g. for full-loop injection in the third injection setup.

Furthermore, during injection of a sample, i.e. when assuming the respective injection configuration C_{I}, and independent of the injection setup there may be no dead volume in the connecting elements comprised by the analytical flow path and preferably in any of the connecting elements of the injection valve.

It will be understood that injection and the step of injecting a sample typically also comprises subsequent separation of the sample in the separation column. That is, separation of the sample may typically be performed in the injection configuration as part of sample injection. This may be advantageous since the solvent flow to the separation column is not interrupted during sample separation.

While FIGS. 1 to 3 each depict the respective injection configuration C_{I} of the system in the three different injection setups, the system may of course also assume further configurations in each injection setup to provide full functionality.

Generally, the system may assume an equilibration configuration C_{E} in each system setup, which may also be referred to as idle configuration. In the equilibration configuration the solvent pump 20 may be fluidly connected to the separation column 30 without the sample loop 50, the sample pickup means 62, the seat 64 or the metering device 40 being part of said fluidic connection. This may allow to wash and equilibrate the separation column 30 with solvent provided by the solvent pump 20.

Preferably the fluidic connection between solvent pump and separation column may be dead-volume free within the injection valve 10, more preferably said fluidic connection may be dead-volume free between the pump outlet and the separation column inlet. In particular, the solvent pump 20 may be fluidly connected to the separation column 30 via a single connecting element and preferably via the first connecting element 120.

Furthermore, the at least one washing pump 80 may be fluidly connected to waste 70, with the seat 64, the sample pickup means 62, the sample loop 50 and the metering device 40 being comprised by said fluidic connection. Thus, when assuming the equilibration configuration C_{E}, the seat 64, the sample pickup means 62, the sample loop 50 and the metering device 40 may be flushed with a solvent provided by the at least one washing pump 80, while the solvent pump 20 may provide a solvent to the separation column 30.

Furthermore, the system may assume a sample pickup configuration C_{P}, wherein the solvent pump 20 may be fluidly connected to the separation column 30, without the sample loop 50, the sample pickup means 62, the seat 64 or the metering device 40 being part of said fluidic connection. This may allow to keep the separation column 30 equilibrated. In particular, the solvent pump 20 may remain fluidly connected to the separation column 30 when switching from the equilibration configuration C_{E} to the sample pickup configuration C_{P}. That is, said fluidic connection may not be interrupted when switching the configuration assumed by the system.

Furthermore, the metering device 40 may be fluidly connected to the sample pickup means 62 and to a dead end. Preferably, the first device connection may be fluidly connected to the sample pickup means 62 and the second device connection may be fluidly connected to a dead end. The sample pickup means 62 may be detached from the seat 64 and located in a sample vial 66. Thus, a sample may be sucked in from the sample vial 66 via the metering device 40 by moving the piston 44 out of the housing 42 to create the required negative pressure.

The system may also assume a sample precompression configuration C_{C}, wherein the solvent pump 20 may be fluidly connected to the separation column 30, without the sample loop 50, the sample pickup means 62, the seat 64 or the metering device 40 being part of said fluidic connection. This may allow to keep the separation column 30 equilibrated. In particular, the solvent pump 20 may remain fluidly connected to the separation column 30 when switching from the sample pickup configuration C_{P} to the sample precompression configuration C_{P}. That is, said fluidic connection may not be interrupted when switching the configuration assumed by the system.

In the sample precompression configuration C_{C} the metering device may generally be fluidly connected to two dead ends, wherein the sample loop 50, the sample pickup means 62 and the seat 64 are comprised by said fluidic connections. In particular, the metering device may comprise two device connections and both device connections may be fluidly connected to a dead end. This may allow to pressurize the sample comprised in the sample loop 50 by means of the metering device 40. In particular, this configuration C_{C} may allow to bring the sample loop 50 to system pressure by moving the piston 44 of the metering device 40 into the housing 42 to increase the pressure. This can advantageously allow to avoid pressure charges when switching the sample loop 50 into the analytical path.

The system may assume a pickup wash configuration C_{WP}, wherein an outer portion of the sample pickup means 62 may be washed. In this configuration C_{WP}, the sample pickup means 62 may be detached from the seat 64, while at least a tip of the sample pickup means may remain within an inner volume of the seat 64. For example, only 5% to 15% (e.g., 10%) of the sample pickup means 62 may remain within the inner volume of the seat 64. Furthermore, the at least one washing pump 80 may be fluidly connected to the seat 64. This may advantageously allow the at least one washing pump 80 to supply a flow of solvent to the seat 64, which may in turn overflow whereby at least the tip the sample pickup means 62 is emersed in the solvent flow and thus washed. In particular, remainders of sample sticking to the outer portion of the sample pickup means 62 (particularly the tip) may be washed away. Preferably, the seat 64 may comprise a direct connection to waste, i.e. an overflow drain, such that overflowing washing fluid may be directly drained to waste.

Generally, the system may allow for providing a continuous, uninterrupted fluid flow to the separation column 30 with the solvent pump 20 when switching between assuming the equilibration configuration C_{E}, the sample pickup configuration C_{P}, the precompression configuration C_{C} and optionally, depending on the injection setup the pickup wash configuration C_{WP} (for the first and second injection setup), and/or a metering device compression configuration C_{MC} (for the second and third injection setup). In other words, the system may be configured to provide an uninterrupted fluid flow, preferably solvent flow, to the separation column 30 beginning with equilibration and up to and including sample precompression. Thus, the separation column 30 can be kept equilibrated right up to the moment of sample injection.

Additionally, the system may assume leak test configurations that allow to test certain components of the system for leaks. For example, in all of the system setups a pump leak test configuration C_{LP} may be assumed, wherein the solvent pump 20 may be fluidly connected to a dead end without the separation column 30, the metering device 40, the sample loop 50, the sample pickup means 62 or the seat 64 being part of said fluidic connection. Particularly, the first connecting element 120 of the injection valve 10 may not be fluidly connected to another port.

Additionally, the system may assume purge configurations configured for purging specific system components.

In particular, the system may assume a pump purge configuration C_{PP}, wherein the solvent pump 20 is fluidly connected to waste 70 without the metering device 40, the sample loop 50, the sample pickup means 62, the seat 64 or the separation column 30 being part of said fluidic connection. Preferably, the solvent pump 20 may be fluidly connected to waste solely via the first connecting element 120, i.e., without any other connecting element of the injection valve being involved.

Furthermore, the system may assume a metering device purge configuration C_{PM}, wherein the metering device 40 is fluidly connected to the solvent pump 20 and to either one of the waste 70 or the sample pick up means 62, allowing the solvent pump to purge the metering device.

Depending on the injection setup, the system may assume further configurations, which will be briefly discussed below, when briefly discussing the configurations assumed by the system for each of the three injection setups.

With reference to FIGS. 4 to 13 configurations assumed when being in the first injection setup S₁ are discussed.

FIG. 4 depicts the exemplary system in the first injection setup S₁ and assuming the equilibration configuration C_{E}. Here, the solvent pump 20 may be fluidly connected to the separation column 30 via the first connecting element 120. More specifically, the first port 102 may be fluidly connected to the second port 104 solely via the first connecting element 120. In the depicted embodiment, the fluidic connection between solvent pump and separation column is dead-volume free within the injection valve 10.

With reference to FIG. 5, the sample pickup configuration C_{P} for the system in the first injection setup S₁ is depicted. In this configuration the separation column 30 remains fluidly connected to the solvent pump 20, wherein the fluidic connection in the depicted embodiment is no longer dead-volume free. In particular, the system may change from assuming the equilibration configuration C_{E} to assuming the sample pickup configuration without interrupting a fluid flow from the solvent pump 20 to the separation column 30.

In the first injection setup S₁, the sample loop 50 is comprised by the fluidic connection of the metering device 40 to the sample pickup means 62. Thus, a sample may be directly sucked from the sample vial 66 into the sample loop 50 by means of the metering device 40, where it may be stored for subsequent injection.

If desired, the system 1 may optionally assume the equilibration configuration once again to drain solvent from the metering device 40 to waste 70, which may advantageously allow to draw in further sample when returning to the sample pickup configuration C_{P}. Thus, in case there is a desire to analyse a larger sample, multiple portions of the sample can be drawn in, with the solvent in the metering device 40 being drained in between. That is, after drawing in a portion of the sample in the sample-pickup configuration S₁-C_{P}, the system may assume the equilibration configuration S₁-C_{E} to drain the solvent within the metering device 40 to waste 70 by moving the piston 44 into the housing 42. Subsequently the system can return to the sample-pickup configuration S₁-C_{P} and draw in another portion of the sample. This can be repeated until sufficient amount of sample is stored in the sample loop 50.

After picking up a sample in the first injection setup S₁, the respective pickup wash configuration C_{WP} may be assumed, wherein an outer portion of the sample pickup means 62 may be washed. With respect to FIG. 6, said configuration may correspond to the equilibration configuration S₁-C_{E}, with the difference that the sample pickup means 62 may be fluidly detached from the seat 64, while at least the tip of the sample pickup means may remain within an inner volume of the seat 64. For example, only 5% to 15% (e.g., 10%) of the sample pickup means 62 may remain within the inner volume of the seat 64. This may advantageously allow a solvent provided by the at least one washing pump 80 to the seat 64 to flow around the tip of the sample pickup means 62 and out of the seat 64 to wash away any remainders of sample sticking to the outer portion of the sample pickup means 62 (particularly the tip). Preferably, the seat 64 may comprise a direct connection to waste, such that the washing fluid may be directly drained to waste.

With reference to FIG. 7, the sample precompression configuration C_{C} for the system in the first injection setup S₁ is depicted. Generally, said configuration C_{C} may be similar to the sample pickup configuration S₁-C_{P} in that the injection valve 10 may assume the same valve position, while the sample pickup means 62 may be in the seat 64 to establish a fluidic connection thereto. Thus, the metering device 40 is fluidly connected to two dead ends such that the sample in the sample loop 50, which is comprised by one of the fluidic connections to a dead end, may be pressurized to system pressure.

After sample precompression the system in the first injection setup may assume the injection configuration S₁-C_{I}.

Subsequently, the system may return to the precompression configuration S₁-C_{C} to decompress the sample loop 50 and the metering device 40 by moving the piston 44 out of the housing 42. This may advantageously allow to prevent pressure surges when fluidly connecting the sample loop 50 and/or the metering device 40 to ambient pressure, e.g. when assuming the equilibration configuration S₁-C_{E} and fluidly connecting the metering device 40 to waste 70.

With reference to FIG. 8, the pump leak test configuration C_{LP} for the system in the first injection setup S₁ is depicted. In this configuration, the solvent pump 20 may be fluidly connected to a dead end. More specifically the first connecting element 120 may only be fluidly connected to the first port 102 and thus the solvent pump 20. Thus, the solvent pump 20 may build up a pressure at the pump outlet, which may allow to detect any leaks at the solvent pump and/or the fluidic connection up to the first connecting element 120.

With reference to FIG. 9, the system in the first injection setup S₁ may also assume a system leak test configuration C_{LS}. In this configuration S₁-C_{LS} the solvent pump may be fluidly connected to a dead end, wherein said fluidic connection comprises the metering device 40, the sample loop 50, the sample pickup means 62 and the seat 64, but not the separation column 30. Thus, all of the comprised components and the involved fluidic connections, ports and connecting elements may be pressurized to allow for identifying presence of a leak.

With reference of FIG. 10, the system in the first injection setup S₁ may also assume a metering device leak test configuration C_{LM}, wherein the solvent pump may be fluidly connected to a dead end and wherein said fluidic connection comprises the metering device 40 but not the sample loop 50, the seat 64, the sample pickup means 62 or the separation column 30. Thus, a leak in the metering device 40 or associated fluidic connections, ports and connecting elements may be identified.

With reference to FIG. 11, the system in the first injection setup S₁ may also assume a pickup means leak test configuration C_{LSP}, wherein particularly the sample pickup means 62 and the seat 64 may be leak tested. This may particularly allow to leak test the fluidic connection between the sample pickup means 62 and the seat 64. In this configuration S₁-C_{LSP} the solvent pump 20 may be fluidly connected to a dead end, wherein said fluidic connection comprises the sample loop 50, the sample pickup means 62 and the seat 64, but not the metering device 40 or the separation column 30.

With reference to FIG. 12, the pump purge configuration C_{PP} for the system in the first injection setup S₁ is depicted. In this configuration the solvent pump 20 is fluidly connected to waste 70 solely via the first connecting element 120. That is, the first connecting element 120, may directly fluidly connect the first port 102 to the fifth port 110, which is directly fluidly connected to waste 70.

With reference to FIG. 13, the metering device purge configuration C_{PM} for the system in the first injection setup S₁ is depicted. In this configuration the solvent pump 20 is fluidly connected to the sample pickup means 62, which is disconnected and removed from the seat 64 and said fluidic connection comprises the metering device 40. Thus, the metering device 40 may be flushed with solvent provided by the solvent pump 20 to and through the metering device 40, which may be disposed of at the sample pickup means 62, which may for example be moved to a waste, e.g. the waste 70. Alternatively, the sample pickup means 62 may be moved over the seat (or closely next to it) and the washing solution may be drained via an overflow drain of the seat, which may be fluidically connected to waste 70.

Thus, the system 1 may be fully operational in the first injection setup S₁. In particular, the separation column 30 can be equilibrated, a sample can be picked up, if desired also multiple portions of a sample can be picked up, and the sample can be precompressed, injected and separated by the separation column 30 for further analysis. Additionally, system components can be washed, e.g. using the at least one washing pump 80, and purged using the solvent pump 20. Additionally, different leak test configurations may be assumed to check for leaks and potentially narrow down their location.

Again, the first injection setup allows for adjustment of the GDV by means of the metering device 40, which is comprised by the analytical path. This may for example be advantageous when emulating methods that have previously been implemented on older systems with a larger GDV. Additionally, all components comprised by the analytical path are also flushed during analysis. This, a risk of carryover may advantageously be reduced (e.g. minimized) and components may be filled with a starting gradient for a subsequent analysis run.

With reference to FIGS. 14 to 23 configurations assumed when being in the second injection setup S₂ are discussed.

FIG. 14 depicts the exemplary system in the second injection setup S₂ and assuming the equilibration configuration C_{E}. The solvent pump 20 may be fluidly connected to the separation column 30 via the first connecting element 120. More specifically, the first port 102 may be fluidly connected to the second port 104 solely via the first connecting element 120. In the depicted embodiment, the fluidic connection between pump and separation column is dead-volume free.

With reference to FIG. 15, the sample pickup configuration C_{P} for the system in the second injection setup S₂ is depicted. In this configuration the separation column 30 remains fluidly connected to the solvent pump 20, wherein the fluidic connection in the depicted embodiment is no longer dead-volume free. In particular, the system may change from assuming the equilibration configuration to assuming the sample pickup configuration without interrupting a fluid flow from the solvent pump 20 to the separation column 30.

Similar to the first injection setup S₁, in the second injection setup S₂, the sample loop 50 is comprised by the fluidic connection of the metering device 40 to the sample pickup means 62. Thus, a sample may be directly sucked from the sample vial 66 into the sample loop 50 by means of the metering device 40 and stored therein for subsequent injection. Again, the system may optionally assume the equilibration configuration S₂-C_{E} once again to drain solvent from the metering device 40 to waste 70, which may advantageously allow to draw in further sample when returning to the sample pickup configuration S₂-C_{P}, as outlined above for the system in the first injection setup S₁.

With reference to FIG. 16, the pickup wash configuration C_{WP} for the system in the second injection setup S₂ is depicted, wherein an outer portion of the sample pickup means 62 may be washed. Again, said configuration may correspond to the equilibration configuration S₂-C_{E}, with the difference that the sample pickup means 62 is fluidly detached from the seat 64, while at least the tip of the sample pickup means may remain within an inner volume of the seat 64. For example, only 5% to 15% (e.g., 10%) of the sample pickup means 62 may remain within the inner volume of the seat 64. This may advantageously allow a solvent provided by the at least one washing pump 80 to the seat 64 to flow around the tip of the sample pickup means 62 and out of the seat to wash away any remainders of sample sticking to the outer portion of the sample pickup means 62 (particularly the tip). Again, the seat 64 may preferably comprise a direct connection to waste, such that the washing fluid may be directly drained to waste.

With reference to FIG. 17, the sample precompression configuration C_{C} for the system in the second injection setup S₂ is depicted. Again, said configuration S₂-C_{C} may be similar to the sample pickup configuration S₂-C_{P} in that the injection valve 10 may assume the same valve position, while the sample pickup means 62 may be in the seat 64 to establish a fluidic connection thereto. Thus, the metering device 40 is fluidly connected to two dead ends such that the sample in the sample loop 50, which is comprised by one of the fluidic connections to a dead end, may be pressurized to system pressure.

With reference to FIG. 18, the system may also assume a metering device compression configuration C_{MC} in the second injection setup S₂, wherein the metering device 40 may be decompressed by moving the piston out of the housing. Thus, the pressure within in the metering device 40 may for example be brought down to ambient pressure. In particular, in the metering device compression configuration C_{MC}, the metering device 40 may be fluidly disconnected form the sample loop 50 such that the sample loop may remain at an elevated pressure, e.g. system pressure. That is, the metering device 40 may be fluidly connected to two dead ends without the sample loop 50, the sample pickup means 62, the seat 64 or the separation column being part of said fluidic connection. Such a decompression of the metering device 40 may advantageously reduce strain on the metering device and/or avoid uncontrolled pressure charges which may occur due to uncontrolled pressure losses (e.g. through leaks) when subsequently switching the metering device 40 back into a flow path at system pressure. In other words, during long analyses, leaks may cause the pressure in the metering device to drop and lead to pressure surges the next time the switching position is changed, e.g. after the analysis. Controlled decompression and compression may advantageously avoid this problem.

After sample precompression and optionally decompressing the metering device, the system in the second injection setup S₂ may assume the injection configuration S₂-C_{I}. Subsequently, the system may optionally return to the metering device compression configuration C_{MC} to precompress the metering device, i.e. to pressurize the metering device preferably to system pressure. This may avoid pressure surges when returning to the precompression configuration S₂-C_{C}. Generally, the system may return to the precompression configuration S₂-C_{C} to decompress the sample loop 50 and the metering device 40 by moving the piston 42 out of the housing 44.

With reference to FIG. 19, the pump leak test configuration C_{LP} for the system in the second injection setup S₂ is depicted. In this configuration, the solvent pump 20 may be fluidly connected to a dead end. More specifically the first connecting element 120 may only be fluidly connected to the first port 102 and thus the solvent pump 20. Thus, the solvent pump 20 may build up a pressure at the pump outlet, which may allow to detect any leaks at the solvent pump and/or the fluidic connection up to the first connecting element 120.

With reference to FIG. 20, the system in the second injection setup S₂ may also assume a metering device leak test configuration C_{LM}, wherein the solvent pump may be fluidly connected to a dead end and wherein said fluidic connection comprises the metering device but not the sample loop 50, the seat 64, the sample pickup means 62 or the separation column 30. Thus, a leak in the metering device 40 or associated fluidic connections, ports and connecting elements may be identified.

With reference to FIG. 21, the system in the second injection setup S₂ may also assume a pickup means leak test configuration C_{LSP}, wherein particularly the sample pickup means 62 and the seat 64 may be leak tested. This may particularly allow to leak test the fluidic connection between the sample pickup means 62 and the seat 64. In this configuration C_{LSP} the solvent pump 20 may be fluidly connected to a dead end, wherein said fluidic connection comprises the sample loop 50, the sample pickup means 62 and the seat 64, but not the metering device 40 or the separation column 30.

With reference to FIG. 22, the pump purge configuration C_{PP} for the system in the second injection setup S₂ is depicted. In this configuration the solvent pump 20 is fluidly connected to waste 70 solely via the first connecting element 120. That is, the first connecting element 120, may directly fluidly connect the first port 102 to the sixth port 112, which is directly fluidly connected to waste 70.

With reference to FIG. 23, the metering device purge configuration C_{PM} for the system in the second injection setup S₂ is depicted. In this configuration the solvent pump 20 is fluidly connected to waste 70, wherein said fluidic connection comprises the metering device 40. Thus, the metering device 40 may be flushed with solvent provided by the solvent pump 20 to and through the metering device 40, which may be disposed of at the waste 70.

Thus, the system may be fully operational in the second injection setup S₂. In particular, the separation column 30 can be equilibrated, a sample can be picked up, if desired also multiple portions of a sample can be picked up, and the sample can be precompressed, injected and separated by the separation column 30 for further analysis. Additionally, system components can be washed, e.g. using the at least one washing pump 80 and purged using the solvent pump 20. Additionally, different leak test configurations may be assumed to check for leaks and potentially narrow down their location. In contrast to the first injection setup S₁, the second injection setup S₂ allows for decompression and precompression of only the metering device, such that it may be kept at ambient pressure during sample injection.

Generally, the second injection setup allows for sample injection without the metering device being comprised by the analytical path which results in a comparatively lower GDV, which may generally be favourable as it can for example reduce the overall runtime of an analysis method.

With reference to FIGS. 24 to 32 configurations assumed when being in the third injection setup S₃ are discussed.

FIG. 24 depicts the exemplary system in the third injection setup S₃ and assuming the equilibration configuration C_{E}. The solvent pump 20 may be fluidly connected to the separation column 30 via the first connecting element 120. More specifically, the first port 102 may be fluidly connected to the fifth port 110 solely via the first connecting element 120. In the depicted embodiment, the fluidic connection between pump and separation column is dead-volume free.

With reference to FIG. 25, the sample pickup configuration C_{P} for the system in the third injection setup S₃ is depicted. In this configuration the separation column 30 remains fluidly connected to the solvent pump 20, wherein the fluidic connection in the depicted embodiment is no longer dead-volume free. In particular, the system may change from assuming the equilibration configuration to assuming the sample pickup configuration without interrupting a fluid flow from the solvent pump 20 to the separation column 30.

In the third injection setup S₃, the sample loop 50 is not comprised by the fluidic connection of the metering device 40 to the sample pickup means 62 in the sample pickup configuration S₃-C_{P}. Thus, a sample may initially be sucked from the sample vial 66 into a tube fluidly connecting the sample pickup means 62 to the metering device 40, which may serve as a temporary sample storage. Again, the sample by be sucked from the sample vial 66 by means of the metering device 40. Subsequently the system may assume the equilibration configuration S₂-C_{E} again to load the sample into the sample loop. In particular, the metering device may push the sample into the sample loop 50, storing the sample in the sample loop for subsequent injection.

If desired, the system may then return to the sample pickup configuration C_{P} to pick up another portion of sample from the vial 66. In contrast to the first injection setup S₁ and the second injection setup S₂, the metering device 40 does not need to be drained since it is used for loading the sample to the sample loop. Instead, it will be understood that solvent may be drained from the sample loop to waste when sample is pushed into the sample loop 50 by the metering device 40, i.e. when the sample is loaded into the sample loop.

With respect to FIG. 26, the sample precompression configuration C_{C} for the system in the third injection setup S₃ is depicted. In this configuration S₃-C_{C} the metering device 40 may be fluidly connected to two dead ends, wherein the sample pickup means 62, the seat 64 and the sample loop 50 are comprised by said fluidic connection. Thus, the metering device may allow to pressurize the sample loop to system pressure. At the same time, the solvent pump 20 may remain fluidly connected to the separation column 30.

Similar to the system in the second injection setup S₂, the system in the third injection setup S₃ may also allow for assuming a metering device compression configuration C_{MC}. With reference to FIG. 27, such a configuration S₃-C_{MC} may allow for decompressing the metering device 40 while keeping the sample loop in a precompressed state, e.g. at system pressure. In particular, the pressure within the metering device 40 may be reduced by moving the piston 44 out of the housing 42. It may preferably be reduced to ambient pressure.

In particular, in the metering device compression configuration S₃-C_{MC}, the metering device 40 may be fluidly disconnected form the sample loop 50 such that the sample loop may remain at an elevated pressure, e.g. system pressure. That is, the metering device 40 may be fluidly connected to two dead ends without the sample loop 50 or the separation column being part of said fluidic connection. Again, such a decompression of the metering device 40 may advantageously reduce strain on the metering device and/or avoid uncontrolled pressure charges which may occur due to uncontrolled pressure losses (e.g. through leaks) when subsequently switching the metering device back into a flow path at system pressure.

After sample precompression and optionally decompressing the metering device the system in the third injection setup may assume the injection configuration S₃-C_{I}.

With reference to FIG. 28, the pickup wash configuration C_{WP} of the system in the third injection setup S₃ is depicted, wherein an outer portion of the sample pickup means 62 may be washed. In the third injection setup S₃ said configuration may correspond to the injection configuration S₃-C_{I}, with the difference that the sample pickup means 62 is fluidly detached from the seat 64, while at least the tip of the sample pickup means may remain within an inner volume of the seat 64. For example, only 5% to 15% (e.g., 10%) of the sample pickup means 62 may remain within the inner volume of the seat 64. This may advantageously allow a solvent provided by the at least one washing pump 80 to the seat 64 to flow around the tip of the sample pickup means 62 and out of the seat to wash away any remainders of sample sticking to the outer portion of the sample pickup means 62 (particularly the tip). Thus, in contrast to the first injection setup S₁ and the second injection setup S₂, the sample pickup means 62 may be washed during sample injection. Preferably, the seat 64 may comprise a direct connection to waste, such that the washing fluid may be directly drained to waste.

After injecting the sample (and optionally washing the sample pickup means 62), the system may optionally return to the metering device compression configuration S₃-C_{MC} to precompress the metering device, i.e. to pressurize the metering device preferably to system pressure. This may avoid pressure surges when returning to the precompression configuration S₃-C_{C}. Generally, the system may return to the precompression configuration S₃-C_{C} to decompress the sample loop 50 and the metering device 40 by moving the piston 42 out of the housing 44.

With reference to FIG. 29, the pump leak test configuration C_{LP} for the system in the third injection setup S₃ is depicted. In this configuration, the solvent pump 20 may be fluidly connected to a dead end. More specifically the first connecting element 120 may only be fluidly connected to the first port 102 and thus the solvent pump 20. Thus, the solvent pump 20 may build up a pressure at the pump outlet, which may allow to detect any leaks at the solvent pump and/or the fluidic connection up to the first connecting element 120.

With reference to FIG. 30, the system in the third injection setup S₃ may also assume a system leak test configuration C_{LS}. In this configuration S₃-C_{LS} the solvent pump may be fluidly connected to a dead end, wherein said fluidic connection comprises the metering device 40, the sample pickup means 62 and the seat 64, but not the sample loop 50 or separation column 30. Thus, all of the comprised components and the involved fluidic connections, ports and connecting elements may be pressurized to allow for identifying presence of a leak.

With reference to FIG. 31, the pump purge configuration C_{PP} for the system in the third injection setup S₃ is depicted. In this configuration the solvent pump 20 is fluidly connected to waste 70 solely via the first connecting element 120. That is, the first connecting element 120, may directly fluidly connect the first port 102 to the seventh port 114, which is directly fluidly connected to waste 70.

With reference to FIG. 32, the metering device purge configuration C_{PM} for the system in the third injection setup S₃ is depicted. In this configuration S₃-C_{PM} the solvent pump 20 is fluidly connected to the sample pick up means 62, which is disconnected and removed from the seat 64, and said fluidic connection comprises the metering device 40. Thus, the metering device 40 may be flushed with solvent provided by the solvent pump 20 to and through the metering device 40, which may be disposed of at the sample pickup means 62, which may for example be moved to a waste, e.g. the waste 70.

Thus, the system may be fully operational in the third injection setup S₃. In particular, the separation column 30 can be equilibrated, a sample can be picked up, if desired also multiple portions of a sample can be picked up, and the sample can be precompressed, injected and separated by the separation column 30 for further analysis. Additionally, system components can be washed, e.g. using the at least one washing pump 80 and purged using the solvent pump 20. Additionally, different leak test configurations may be assumed to check for leaks and potentially narrow down their location.

Again, the third injection setup allows for pushed-loop injections, particularly full-loop injections and/or partial-loop injections, wherein only the sample loop 50 and neither the metering device 50 not the sample pickup means 62 and seat 64 is comprised in the analytical path. This may allow to repeatedly inject a precise volume of sample and, depending on the sample loop volume allow to further reduce the GDV compared to the other injection setups, but may require excess sample for loading the sample loop.

With reference to FIGS. 33 and 34, the present invention also relates to a respective method for operating a chromatography system, wherein the chromatography system comprises an injection valve 10 comprising at least 8 ports 102, 104, 106, 108, 110, 112, 114, 116, a metering device 40, a separation column 30, a solvent pump 20, a sample loop 50, a waste 70, at least one washing pump 80, and a sample pickup means 62 and a seat 64 for receiving the sample pick-up means. Generally, the chromatography system may comprise features as described above with respect to FIGS. 1 to 32.

The method comprises operating the chromatography system in a first injection setup S₁, a second injection setup S₂ and a third injection setup S₃, wherein in each injection setup different system components are comprised in an analytical path between the solvent pump 20 and the separation column 30 during sample injection. Thus, very generally the method may comprise operating the system as outlined herein, particularly also within the above description of the system.

In other words, the method may comprise the step 210 of operating the system in the first injection setup S₁, the step 220 of operating the system in the second injection setup S₂ and the step 230 of operating the system in the third injection setup S₃ (see FIG. 33). It will be understood that these three injection setups are different to each other and may particularly be characterized by comprising different components in the analytical path between solvent pump and separation column during injection. Furthermore, it will be understood that these steps 210, 220, 230 may be performed in an arbitrary order.

Furthermore, changing between the different injection setups may not require any hardware modifications other than changing fluidic connections between components and optionally changing the sample loop, e.g. to provide desired sample loop volume. In other words, the system hardware may be the same in all three injection setups. In particular the injection valve may be the same for all three injections setups. Thus, for example the rotor (and any grooves within the rotor) may be identical for all three injection setups.

With reference to FIG. 34 operating the system in any one of the three injection setups may comprise the step 302 of equilibrating the separation column with solvent provided by the solvent pump, the step 304 of picking up a sample using the metering device and sample pickup means, the step 306 of storing the sample in the sample loop, the step 308 of pressurizing the sample in the sample loop, the step 310 of injecting the sample stored in the sample loop into the separation column, and the step 312 of depressurizing the sample loop and the metering device.

The step 302 of equilibrating the separation column with solvent provided by the solvent pump may comprise the system assuming the respective equilibration configuration C_{E}, in the respective injection setup, wherein the solvent pump is fluidly connected to the separation column without the sample loop, the sample pickup means, the seat or the metering device being part of said fluidic connection. Further details regarding the equilibration of the separation column, and the equilibration configuration C_{E} in general and specific to the different injection setups are provided above.

The step 304 of picking up a sample using the metering device and the sample pickup means may comprise the system assuming the respective sample pickup configuration C_{P} in the respective injection setup, wherein a first device connection of the metering device is fluidly connected to the sample pickup means and a second device connection of the metering device is fluidly connected to a dead end, and wherein the sample pickup means is separated from the seat and moved to a sample vial. Further details regarding the picking up of the sample, and the sample pickup configuration C_{P} in general and specific to the different injection setups are provided above.

The step 306 of storing the sample in the sample loop may be performed simultaneously with step 304 of picking up the sample in the first injection setup S₁ and the second injection setup S₂. That is, the sample may be directly sucked into and stored in the sample loop directly fluidly attached to the sample pickup means when operating the system in the first injection setup S₁ or the second injection setup S₂.

In contrast, when operating the system in the third injection setup S₃, the sample may be separately loaded into the sample loop, which may not be directly fluidly connected to the sample pickup means. In this injection setup S₃ the equilibration configuration S₃-C_{E} may be assumed after picking up the sample and at least a portion of the picked-up sample may be pushed into the sample loop by means of the metering device.

Optionally, the steps 306 and 308 may be repeated to provide a multidraw method, wherein a plurality of portions of sample are picked up and stored in the sample loop. That is, the steps of picking up the sample and storing it may comprise repeatedly drawing in a portion of sample from a sample vial and storing it in the sample loop, with interrupted removal of solvent from the metering device. It will be understood that in the third injection setup the solvent is removed from the metering device when pushing the sample into the sample loop, while it may be separately drained from the metering device in the first and second injection setup. In particular, when operating in the first injection setup S₁ or in the second injection setup S₂, the system may assume the respective equilibration configuration C_{E} for draining solvent from the metering device to waste. Again, further details regarding the pickup and storage of a plurality of sample portions can be found above, e.g., when discussing the different injection setups.

The step 308 of pressurizing the sample in the sample loop may comprise the system assuming the respective sample precompression configuration C_{C} in the respective injection setup, wherein a first device connection and a second device connection of the metering device are both fluidly connected to a dead end, and wherein one of said fluidic connections comprises the sample loop. It will be understood that this step realizes a sample precompression. Further details regarding the pressurization of the sample, and the sample precompression configuration C_{C} in general and specific to the different injection setups are provided above.

The step 310 of injecting the sample stored in the sample loop into the separation column may comprise the system assuming the respective injection configuration C_{I} in the respective injection setup, wherein the sample loop is comprised in the analytical path. Again, further details regarding the injection of the sample, and the injection configuration C_{I} in general and specific to the different injection setups can be found above, e.g., when discussing the respective injection configurations of the different injection setups.

The step 312 of depressurizing the sample loop and the metering device after injecting the sample may comprise the system assuming the sample precompression configuration C_{C}. Again, further details regarding the depressurization of the sample loop and the metering device can be found above.

Furthermore, the method may optionally comprise the step of washing an outer portion of the sample pickup means. Washing the outer portion of the sample pickup means may comprise the system assuming the respective pickup wash configuration C_{WP} in the respective injections setup, wherein the sample pickup means is fluidly detached from the seat while at least the tip of the sample pickup means may remain within an inner volume of the seat, and wherein the at least one washing pump provides a solvent to the seat. Again, further details regarding the washing of the sample pickup means, and the pickup wash configuration C_{WP} in general and specific to the respective injection setups can be found above.

When operating the system in the second injection setup S₂ or in the third injection setup S₃ the method may further comprise depressurizing the metering device, preferably down to ambient pressure, prior to sample injection, and/or pressurizing the metering device, preferably to system pressure, after sample injection. Depressurizing the metering device and/or pressurizing the metering device may comprise the system assuming a respective metering device compression configuration C_{MC} in the respective injection setup, wherein both connections of the metering device are fluidly connected to a respective dead end, without the sample loop, or the separation column being comprised by said fluidic connections. Further details regarding the depressurization and subsequent pressurization of the metering device, and the metering device compression configuration C_{MC} in general and specific to the respective injection setups can be found above.

Additionally, the method may comprise purging the pump, wherein purging the pump may comprise the system assuming a respective pump purge configuration C_{PP} in the respective injection setup, wherein the solvent pump is fluidly connected to waste without the metering device, the sample loop, the sample pickup means, the seat or the separation column being part of said fluidic connection. Further details regarding the purging of the solvent pump and, and the pump purge configuration C_{PP} in general and specific to the respective injection setups can be found above.

The method may comprise, purging the metering device, wherein purging the metering device may comprise the system assuming a respective metering device purge configuration C_{PM} in the respective injection setup, wherein the metering device is fluidly connected to the solvent pump and to either one of the waste or the sample pick up means, allowing the solvent pump to purge the metering device. Further details regarding the purging of the metering device and, and the metering device purge configuration C_{PP} in general and specific to the respective injection setups can be found above.

The method may also comprise performing system diagnostics to detect (and preferably localize) leaks within the system. Performing system diagnostics may for example comprise leak testing the solvent pump, which may comprise the system assuming a respective pump leak test configuration C_{LP}. Depending on the injection setups additional leak test may be performed, which may comprise assuming respective leak test configurations (C_{LS}, C_{LM}, C_{LSP}). More details regarding leak testing of system components and respective leak test configurations can be found above.

Thus, the present invention relates to a chromatography system and a respective method of operating a chromatography system, which enable operation of the system in at least three different injection setups. Thus, advantageously, three different types of sample injection may be available within a single system and particularly a single hardware setup. In other words, a user may only have to change capillary connections to switch to a different injections setup without changing the entire hardware setup. If desired, a user might exchange the sample loop for a sample loop with a desired volume, e.g. for full-loop injection. A computer program product, e.g. software, and electronics, e.g. controller, for operating the system in the different injection setups may also be provided.

In summary, the following injection principles may be realized: Split loop injection with metering device in the analytical path (first injection setup S₁), split loop injection with metering device outside the analytical path (second injection setup S₂) and pushed-loop injections, e.g. full-loop injection or partial-loop injection (third injection setup S₃).

In particular, the three injection setups may be realized using the same injection valve. Advantageously, only a single injection valve may be needed which may save costs, space and other fluidic connections, thus eliminating sources of error such as leaks.

The system and method may also provide an optional sample precompression as well as options for washing system components, at least in some cases even during analysis of a sample (i.e. in the injection configuration C_{I}). This may advantageously allow for reducing the overall runtime of an analysis procedure.

As will be understood from the above, embodiments of the present invention also relate to a valve as such, the valve being configured to be used in liquid chromatography. As will be appreciated, a single valve is used in FIGS. 1 to 32 discussed above, and this valve also forms an independent embodiment of the invention discussed herein. As will be appreciated, this valve is configured to assume different valve positions that have been discussed in the general description, and it will also be understood that the valve positions discussed in the general description correspond to the following Figures:

| Valve position | Figure(s) |
|---|---|
| First valve position | 1, 2, 32 |
| Second valve position | 3, 28 |
| Third valve position | 4, 6, 14, 16 |
| Fourth valve position | 12, 24 |
| Fifth valve position | 5, 7, 15, 17 |
| Sixth valve position | 20, 25, 27 |
| Seventh valve position | 26 |
| Eighth valve position | 8 |
| Ninth valve position | 9 |
| Tenth valve position | 10 |
| Eleventh valve position | 11 |
| Twelfth valve position | 13, 22 |
| Thirteenth valve position | 18 |
| Fourteenth valve position | 19, 29 |
| Fifteenth valve position | 21, 30 |
| Sixteenth valve position | 23, 31 |

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. Method for operating a chromatography system, wherein the chromatography system comprises an injection valve comprising at least 8 ports, a metering device, a separation column, a solvent pump, a sample loop, a waste, at least one washing pump, and a sample pickup means and a seat for receiving the sample pick-up means;
the method comprising
operating the chromatography system in a first injection setup S₁, a second injection setup S₂ and a third injection setup S₃, wherein in each injection setup, different system components are comprised in an analytical path between the solvent pump and the separation column during sample injection.

2. The method according to claim 1, wherein the method comprises switching between the three injection setups S₁, S₂, S₃.

3. The method according to claim 2, wherein switching between injection setups merely comprises reconfiguring fluidic connections between system components and optionally exchanging the sample loop.

4. The method according to claim 1, wherein operating the system in any one of the three injection setups comprises injecting a sample stored in the sample loop into the separation column, wherein injecting a sample comprises the system assuming a respective injection configuration C_{I} in the respective injection setup.

5. The method according to claim 4, wherein the analytical path comprises the sample loop, the sample pickup means, the seat and the metering device when assuming the injection configuration C_{I} while operating the system in the first injection setup S₁.

6. The method according to claim 4, wherein the analytical path comprises the sample loop, the sample pickup means and the seat, but not the metering device, when assuming the injection configuration C_{I} while operating the system in the second injection setup S₂.

7. The method according to claim 4, wherein the analytical path comprises the sample loop, but not the sample pickup means, the seat and the metering device, when assuming the injection configuration C_{I} while operating in the third injection setup S₃.

8. A chromatography system comprising
an injection valve comprising at least 8 ports,
a metering device comprising a first device connection and a second device connection,
a separation column,
a solvent pump,
a sample loop,
a waste,
at least one washing pump, and
a sample pick-up means and a seat for receiving the sample pick-up means;
wherein the system is configured to be operated in a first injection setup S₁, a second injection setup S₂ and a third injection setup S₃, wherein in each injection setup, different system components are comprised in an analytical path between the solvent pump and the separation column during sample injection.

9. The system according to claim 8, wherein the system comprises the same hardware in all three injection setups, and wherein the three injection setups differ in the fluidic connections between system components.

10. The system according to claim 9, wherein at least one of the three injection setups includes a different sample loop from another of the three injection setups.

11. The system according to claim 8, wherein the system in the first injection setup S₁ is configured for split-loop injection with adjustable gradient delay volume.

12. The system according to claim 8, wherein the system in the second injection setup S₂ is configured for split-loop injection with a fixed gradient delay volume, which is lower than in the first injection setup S₁.

13. The system according to claim 8, wherein the system in the third injection setup S₃ is configured for a pushed-loop injection and/or a pulled-loop injection with a fixed gradient delay volume.

14. The system according to claim 13, wherein the pushed-loop injection and/or a pulled-loop injection with a fixed gradient delay volume is a full-loop injection and/or a partial-loop injection.

15. The system according to claim 8, wherein the system is configured to assume a respective injection configuration C_{I} in each of the three injection setups, wherein the analytical path comprises the sample loop.

16. The system according to claim 8, wherein the system comprises a controller configured to control the system, wherein the controller is configured to operate the chromatography system according to the method of operating the chromatography system in a first injection setup S₁, a second injection setup S₂ and a third injection setup S₃, wherein in each injection setup, different system components are comprised in an analytical path between the solvent pump and the separation column during sample injection.

17. A valve for a liquid chromatography system,
wherein the valve comprises at least 8 ports, wherein the at least 8 ports comprise a first port, a second port, a third port, a fourth port, a fifth port, a sixth port, a seventh port, and an eighth port;
wherein the valve comprises at least 4 connecting elements for connecting the ports, wherein the at least 4 connecting elements comprise a first connecting element, a second connecting element, a third connecting element, and a fourth connecting element;
wherein the valve is configured to assume a first valve position, wherein the first connecting element connects the first port and the eighth port free of dead volume, wherein the second connecting element connects the second port and the third port free of dead volume, wherein the third connecting element connects the fourth port and the fifth port free of dead volume, and wherein the fourth connecting element connects the sixth port and the seventh port free of dead volume; and
wherein the valve is configured to assume a second valve position, wherein the first connecting element connects the first port and the fourth port free of dead volume, wherein the second connecting element connects the fifth port and the sixth port free of dead volume, wherein the third connecting element connects the seventh port and the eighth port free of dead volume, and wherein the fourth connecting element connects the second port and the third port free of dead volume.

18. The valve according to claim 17, wherein the valve is a shear valve comprising a rotor and a stator, and wherein the first port is located at a centre of the stator, while the remaining 7 ports are located equally spaced in a circumferential direction on a circle around the first port

19. The valve according to claim 18, wherein the second and third connecting element comprise the shape of an arc oriented along the circle and dimensioned such that they can connect two neighbouring ports on the circle without any dead volume in said connection.

20. The valve according to claim 18, wherein the fourth connecting element comprises a shape that allows to connect two neighbouring ports on the circle both with or without dead volume.

21. The valve according to claim 17, wherein the first connecting element is generally hook-shaped and dimensioned such that it can fluidly connect the first port to each of the other ports, respectively.

22. The valve according to claim 17, wherein the at least 4 connecting elements are provided through grooves in the rotor.
